(19) United States
(12) Patent Application Publication
(10) Pub. No.: US 2011/0199480 A1
(43) Pub. Date: Aug. 18, 2011

(54) OPTICAL INSPECTION SYSTEM USING MULTI-FACET IMAGING

(75) Inventors: Michael LEV, Yokneam (IL); Amir Gilead, Haifa (IL)

(73) Assignee: Camtek LTD., Migdal Haemek (IL)

(21) Appl. No.: 12/828,368

(22) Filed: Jul. 1, 2010

Related U.S. Application Data
(63) Continuation-in-part of application No. 12/664,671, filed on Dec. 28, 2010.
(60) Provisional application No. 61/224,101, filed on Jul. 9, 2009.

(51) Int. Cl. H04N 7/18

(52) U.S. Cl. 348/126; 348/E07.085

(57) ABSTRACT

An optical inspection system, the system includes: (i) an image sensor; and (ii) a single optical element, that at least partially surrounds an edge of an inspected object; wherein the optical element is adapted to direct light from different areas of the edge of the inspected object towards the image sensor so that the image sensor concurrently obtains images of the different areas.

### RELATED APPLICATIONS

This patent application is a continuation in part of U.S. patent application Ser. No. 12/664,671, filing date Dec. 15, 2009 which claims priority from PCT patent application WO 2008/152648 having an international filing date of Jun. 15, 2008, that in turn claims priority from provisional patent Ser. No. 60/944,106 filed on 15 Jun. 2007. This application claims priority of U.S. provisional patent Ser. No. 61/224,101, filing date Jul. 9, 2009 which is incorporated herein by reference.

### FIELD OF THE INVENTION

The invention relates to optical inspections of objects such as but not limited to wafers.

### BACKGROUND OF THE INVENTION

Backside and edge/bevel defects are among those that have silently crept up to the surface of the world of yield limiting defects. The presence of contamination at the backside of a wafer can compromise up to 10% yield of today's advanced semiconductor devices at multiple process steps such as lithography, diffusion, cleans, CMP, and CVD film deposition. Backside defects are not limited to contamination and damage and they also include mechanical scratches that can lead to wafer breakages in the subsequent high temperature processes. With 300 mm wafers, significantly more real estate is located at the wafer edge. Edge yield losses, typically 10 to 40% when normalized and compared to center die yield, has therefore become a major concern.

The increased automation (less manual handling) and the advanced topography requirement of solely using DSP (double side polished) wafers for 300 mm manufacturing also have driven more significant challenges to recognize systematic issues early in the production line.

### SUMMARY

An optical inspection system that includes: an image sensor; and a single optical element, that at least partially surrounds an edge of an inspected object; wherein the optical element is adapted to direct light from different areas of the edge of the inspected object towards the image sensor so that the image sensor concurrently obtains images of the different areas.

An optical inspection system, the includes: an image sensor; and multiple optic fibers that are arranged such as to at least partially surround an edge of an inspected object; wherein the optic fibers are adapted to direct light from the different areas of the edge of the inspected object towards the image sensor so that the image sensor concurrently obtains images of the different areas.

An optical inspection system that includes: an image sensor adapted to concurrently acquire images of an apex of the edge of the inspected object and of opposite areas of the edge of the inspected object that are proximate to the apex; and a single optical element that is adapted to direct light towards the image sensor, from the apex of the edge of the inspected object and from the opposite areas of the edge of the inspected object that are proximate to the apex.

An optical inspection system that includes: an image sensor adapted to concurrently acquire images of an apex of the edge of the inspected object and of opposite areas of the edge of the inspected object that are proximate to the apex; and an array of fibers adapted to direct light towards the image sensor from the apex of an edge of an inspected object and from the opposite areas of the edge of the inspected object that are proximate to the apex.

According to various embodiments of the invention each of the mentioned above systems can be characterized by one of more of the following characteristics or elements listed below (unless there is a contradiction between a mentioned above embodiments of the system and an characteristic or element mentioned below): (i) the optical element is a multi facet reflector; (ii) the optical element directs light from substantially opposite areas of the edge of the inspected object towards the image sensor; (iii) the optical element directs light from a top bevel area and from a bottom bevel area of the edge of the inspected object towards the image sensor; (iv) the optical element directs light from an apex and from at least one bevel area out of a top bevel area and a bottom bevel area of the edge of the inspected object towards the image sensor; (v) the optical element directs light from a top bevel area and a bottom area of the edge of the inspected object; (vi) the optical element directs light from a bottom bevel area and a top area of the edge of the inspected object towards the image sensor; (vii) the optical element directs light from a top bevel area, an apex area and from a top area of the edge of the inspected object towards the image sensor; (viii) the optical element directs light from a bottom bevel area, an apex area and a bottom area of the edge of the inspected object towards the image sensor; (ix) the optical element directs light from at least four areas out of a top area, a top bevel area, a bottom bevel area, an apex area and a bottom area of the edge of the inspected object towards the image sensor; (x) the optical element directs light from a top area, a top bevel area, a bottom bevel area, an apex area and a bottom area of the edge of the inspected object towards the image sensor; (xi) the optical element is adapted to reduce a length difference between different optical paths defined between the different areas and the image sensor; (xii) the system includes a path length adjustment optics that reduces a length difference between different optical paths defined between the different areas and the image sensor; (xiii) the system includes a path length adjustment optics; wherein the path length adjustment optics and the optical element substantially equalize a length of different optical paths defined between the different areas and the image sensor; (xiv) the system includes an inspected object stabilizer that maintains a substantially constant distance between an illuminated portion of the edge of the inspected object and the optical element during a movement of the inspected object in relation to the optical element; (xv) the system includes an optical element mover adapted to move the optical element in relation to an illuminated portion of the edge of the inspected object in response to an estimated location of the illuminated portion of the edge of the inspected object, during a scan of the edge of the inspected object in relation to the optical element; (xvi) the optical element includes multiple portions that differ from each other by at least one optical characteristic; and wherein at a given point of time the different portions of the optical element direct, towards the image sensor, light from different regions of the edge of the inspected element; wherein each region of the edge of the inspected element includes at least two areas of the edge of the inspected element that are oriented in relation to each other; (xvii) the optical element includes multiple portions that differ from each other by at least one optical characteristic; and wherein at a given point of time the different portions of the optical element direct, towards the image sensor, light from different regions of the edge of the inspected element; wherein each region of the edge of the inspected element has an central axis that is substantially perpendicular to a plane defined by an upper surface of the inspected object; (xviii) the image sensor is an area image sensor; (xix) the image sensor is a linear image sensor; (xx) the single optical element includes at least one penta-prism.

Each of the mentioned above systems may include an image sensor that is located above the inspected object and has an optical axis that is substantially parallel to an upper surface of the inspected object; wherein the image sensor has a sensing surface that faces an upper portion of the multi-facet reflector; wherein the system further comprises a stage that rotates the inspected object about a center of the inspected object.

Each of the mentioned above systems may include an image sensor and a mirror that are located above the inspected object; wherein the image sensor has a sensing surface that faces the mirror, wherein an upper portion of the multi-facet reflector faces the mirror; wherein the image sensor, the mirror and the multi-facet reflector are rotated in relation to the inspected object such as to scan the edge of the inspected object.

A method for inspecting an edge of an inspected object, the method includes: illuminating the edge of the inspected object; directing light from different areas of the edge of the inspected object towards an image sensor, by a single optical element, that at least partially surrounds an edge of an inspected object, towards the image sensor; and concurrently obtaining, by the image sensor, images of the different areas.

A method for inspecting an edge of an inspected object, the method includes: illuminating the edge of the inspected object; directing light from different areas of the edge of the inspected object towards an image sensor, by multiple optic fibers that are arranged such as to at least partially surround the edge of an inspected object; concurrently acquiring, by the image sensor, images of the different areas.

A method for inspecting an edge of an inspected object, the method includes: illuminating the edge of the inspected object; directing light, by a single optical element, from an apex of an edge of an inspected object and from opposite areas of the edge of the inspected object that are proximate to the apex towards an image sensor; and concurrently acquiring images, by the image sensor, of the apex of the edge of the inspected object and from the opposite areas of the edge of the inspected object that are proximate to the apex.

A method for inspecting an edge of an inspected object, the method includes: illuminating the edge of the inspected object; directing light, by an array of fibers, from an apex of an edge of an inspected object and from opposite areas of the edge of the inspected object that are proximate to the apex, towards an image sensor; and concurrently acquiring images, by the image sensor, of the apex of the edge of the inspected object and from the opposite areas of the edge of the inspected object that are proximate to the apex.

According to various embodiments of the invention each of the mentioned above methods can be characterized by one of more of the following characteristics or stages listed below (unless there is a contradiction between a mentioned above embodiment of the method and a characteristic or element mentioned below): (i) directing light by an optical element that is a multi facet reflector; (ii) directing light from substantially opposite areas of the edge of the inspected object towards the image sensor; (iii) directing light from a top bevel area and from a bottom bevel area of the edge of the inspected object towards the image sensor; (iv) directing light from an apex and from at least one bevel area out of a top bevel area and a bottom bevel area of the edge of the inspected object towards the image sensor; (v) directing light from a top bevel area and a bottom area of the edge of the inspected object; (vi) directing light from a bottom bevel area and a top area of the edge of the inspected object towards the image sensor; (vii) directing light from a top bevel area, an apex area and from a top area of the edge of the inspected object towards the image sensor; (viii) directing light from a bottom bevel area, an apex area and a bottom area of the edge of the inspected object towards the image sensor; (ix) directing light from at least four areas out of a top area, a top bevel area, a bottom bevel area, an apex area and a bottom area of the edge of the inspected object towards the image sensor; (x) directing light from a top area, a top bevel area, a bottom bevel area, an apex area and a bottom area of the edge of the inspected object towards the image sensor; (xi) reducing, by the optical element, a length difference between different optical paths defined between the different areas and the image sensor; (xii) reducing, by a path length adjustment optics, a length difference between different optical paths defined between the different areas and the image sensor; (xiii) substantially equalizing, by a path length adjustment optics and the optical element, a length of different optical paths defined between the different areas and the image sensor; (xix) maintaining, by an inspected object stabilizer, a substantially constant distance between an illuminated portion of the edge of the inspected object and the optical element during a movement of the inspected object in relation to the optical element; (xx) moving, by an optical element mover, the optical element in relation to an illuminated portion of the edge of the inspected object in response to an estimated location of the illuminated portion of the edge of the inspected object, during a scan of the edge of the inspected object in relation to the optical element; (xxi) directing, at a given point of time and by the different portions of the optical element, towards the image sensor, light from different regions of the edge of the inspected element; wherein each region of the edge of the inspected element comprises at least two areas of the edge of the inspected element that are oriented in relation to each other; wherein the optical element comprises multiple portions that differ from each other by at least one optical characteristic; (xxii) directing, at a given point of time and by the different portions of the optical element, towards the image sensor, light from different regions of the edge of the inspected element; wherein each region of the edge of the inspected element has an central axis that is substantially perpendicular to a plane defined by an upper surface of the inspected object; wherein the optical element comprises multiple portions that differ from each other by at least one optical characteristic; (xxiii) directing light towards an image sensor that is an area image sensor; (xxiv) directing light towards an image sensor that is a linear image sensor; and (xxv) directing light by a single optical element that includes at least one penta-prism.

Each of the mentioned above methods may include rotating the inspected object about a center of the inspected object while concurrently obtaining images of the different areas by an image sensor that is located above the inspected object and has an optical axis that is substantially parallel to an upper surface of the inspected object; wherein the image sensor has a sensing surface that faces an upper portion of the multi-facet reflector.

Each of the mentioned above methods may include rotating the image sensor, the multi facet reflector, at least one illumination element and a mirror that are located above the inspected object while concurrently obtaining images of the different areas by an image sensor that has a sensing surface that faces the mirror, wherein an upper portion of the multi-facet reflector faces the mirror.

An optical inspection system is provided, it may include: a first image sensor; a second image sensor; a support module for supporting and rotating an inspected object that has an edge that comprises a top area, top bevel area, an apex area, a bottom bevel area and a bottom area; a first optical element, for directing light from the top area, from the top bevel area and from the apex area towards the first image sensor; and a second optical element, for directing light from the bottom area, from the bottom bevel area and from the apex area towards the second image sensor.

An inspection method, the method may include: supporting and rotating an inspected object that has an edge that comprises a top area, top bevel area, an apex area, a bottom bevel area and a bottom area; illuminating the edge of the inspected object; directing, by a first optical element, light from the top area, from the top bevel area and from the apex area towards a first image sensor; concurrently obtaining, by the first image sensor, images of the top area, of the top bevel area and of the apex area; directing, by a second optical element, light from the bottom area, from the bottom bevel area and from the apex area towards a second image sensor; and concurrently obtaining, by the second image sensor, images of the bottom area, of the bottom bevel area and of the apex area.

An optical inspection system, the system may include: a first image sensor; a second image sensor; a support module for supporting and rotating an inspected object that has an edge that comprises a top area, a top bevel area, an apex area, a bottom bevel area and a bottom area; and an illumination unit for illuminating the edge of the inspected object; wherein the top bevel area is oriented by a top bevel angle in relation to the top area; wherein the first image sensor is oriented by a first image sensor angle in relation to the top area, wherein the first image sensor angle is smaller than the top bevel angle; wherein the bottom bevel area is oriented by a bottom bevel angle in relation to the bottom area; wherein the second image sensor is oriented by a second image sensor angle in relation to the bottom area, wherein the second image sensor angle is smaller than the bottom bevel angle.

A method for inspection, the method may include: supporting and rotating an inspected object that has an edge that comprises a top area, a top bevel area, an apex area, a bottom bevel area and a bottom area; illuminating the edge of the inspected object; and imaging the top bevel area and the top area by a first image sensor; imaging the bottom bevel area and the bevel area by a second image sensor; wherein the top bevel area is oriented by a top bevel angle in relation to the top area; wherein the first image sensor is oriented by a first image sensor angle in relation to the top area, wherein the first image sensor angle is smaller than the top bevel angle; wherein the bottom bevel area is oriented by a bottom bevel angle in relation to the bottom area; wherein the second image sensor is oriented by a second image sensor angle in relation to the bottom area, wherein the second image sensor angle is smaller than the bottom bevel angle.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates an edge of a wafer;

FIG. 2 illustrates a wafer and a system according to an embodiment of the invention;

FIG. 3 illustrates an edge of a wafer and a optical element according to an embodiment of the invention;

FIG. 4 illustrates a portion of an edge of a wafer and a portion of an optical element according to an embodiment of the invention;

FIG. 5 illustrates a portion of an edge of a wafer and a portion of an optical element according to an embodiment of the invention;

FIG. 6 illustrates an edge of a wafer, a top optical element and a bottom optical element according to an embodiment of the invention;

FIG. 7 illustrates an edge of a wafer and a top optical element according to an embodiment of the invention;

FIG. 8 illustrates a portion of an edge of a wafer and a portion of an optical element according to an embodiment of the invention;

FIG. 9 illustrates multiple optic fibers and an edge of a wafer according to an embodiment of the invention;

FIG. 10 illustrates a portion of a wafer and an optical element according to an embodiment of the invention;

FIG. 11 illustrates a portion of a wafer and an optical element according to an embodiment of the invention;

FIG. 11 illustrates a portion of a wafer and an optical element according to an embodiment of the invention;

FIG. 12 illustrates a portion of a wafer, illumination elements, an optical element and an image sensor, according to an embodiment of the invention;

FIG. 13 is a flow chart according to an embodiment of the invention;

FIG. 14 is a flow chart according to an embodiment of the invention;

FIG. 15 is a flow chart according to an embodiment of the invention;

FIG. 16 is a flow chart according to an embodiment of the invention;

FIG. 17 illustrates a system and an inspected object according to an embodiment of the invention;

FIG. 18 illustrates a first scan unit according to an embodiment of the invention;

FIG. 19 illustrates a second scan unit according to an embodiment of the invention;

FIG. 20 illustrates a first scan unit according to another embodiment of the invention;

FIG. 21 illustrates a second scan unit according to another embodiment of the invention;

FIG. 22 illustrates an edge of an inspected object and two image sensors according to an embodiment of the invention;

FIG. 23 illustrates a calibration unit according to an embodiment of the invention;

FIG. 24 illustrates a review unit according to an embodiment of the invention;

FIG. 25 illustrates a second review unit according to an embodiment of the invention;

FIG. 26 illustrates a first review unit according to an embodiment of the invention;

FIG. 27 illustrates an inspection method according to an embodiment of the invention;

FIG. 28 illustrates an inspection method according to an embodiment of the invention;

FIGS. 29-31 illustrate inspection systems and a wafer according to various embodiments of the invention; and

FIGS. 32-33 are flow charts of methods according to various embodiments of the invention.

### DETAILED DESCRIPTION OF THE DRAWINGS

An optical inspection system and a method are provided. The inspection system and method can detect defects that are close to the edge of an inspected object (such as, but not limited to, a wafer). The system is able to illuminate multiple facets of the object concurrently and detect light reflected and/or scattered from these illuminated facets. The detection can be implemented by using a single image sensor, such as but not limited to a video camera.

The system defines multiple optical paths that deflect light rays reflected from each facet of interest such that all light rays are focused on the image sensor surface.

The system and method can be utilized for various purposes (applications) such as but not limited to detection of defects of various sizes, down to micron level defects in the top, top near edge, apex, bottom near edge and bottom surfaces at the periphery of thin substrates, such as wafers used in the production of semiconductor or MEMS devices, or solar cells.

A method is provided. The method includes: illuminating a multi facet object using a multi facet deflector; collecting light reflected and, additionally or alternatively, scattered from multiple facets of the object while using the multi facet deflector; and detecting defects based upon the collected light. Conveniently two opposing facets of the multi facets are illuminated concurrently during the illuminating. Conveniently, the illuminating includes illuminating the multi facet object by a multi facet deflector that includes light guides.

It is noted that any combination of any stage of any method (or methods) illustrated below can be provided.

It is noted that any combination of any component of any system (or systems) illustrated below can be provided.

For simplicity of explanation, some of the following figures refer to a wafer. It is noted that other inspected objects (such as but not limited to a thin substrate) can be inspected by either one of the below mentioned systems and by either one of the below mentioned methods.

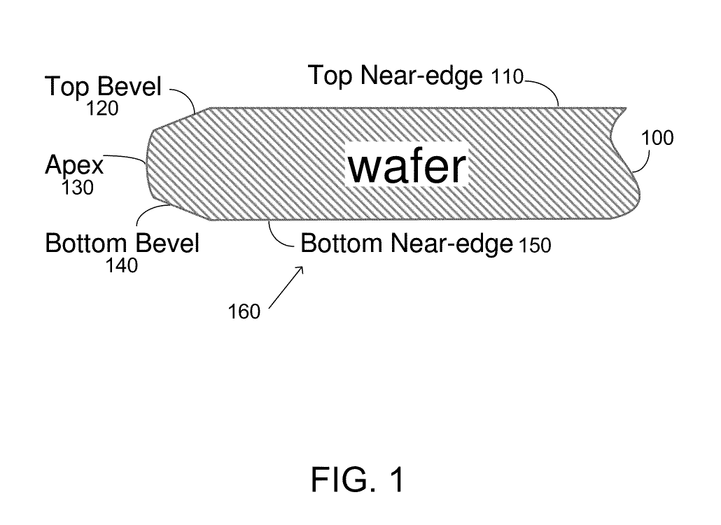

FIG. 1 depicts a cross section of an edge of an inspected object such as wafer 100.

Edge 160 of wafer 100 includes five surfaces (facets) of interest that the method and system can inspect simultaneously—top facet 110, top bevel facet 120, apex 130, bottom bevel facet 140 and bottom facet 150. It is noted that top facet 110 and bottom facet 150 can extend out of edge 160. For simplicity of explanation they are viewed as including only portions of these facets that are proximate to apex 130.

It is noted that the below mentioned methods and systems can be applied mutatis mutandis to inspect objects having fewer surfaces of interest, such as having a rectangular cross section, or more.

It is noted that in some of the following figures these numbers (110, 120, 130, 140 and 150) are not shown—for convenience of explanation only.

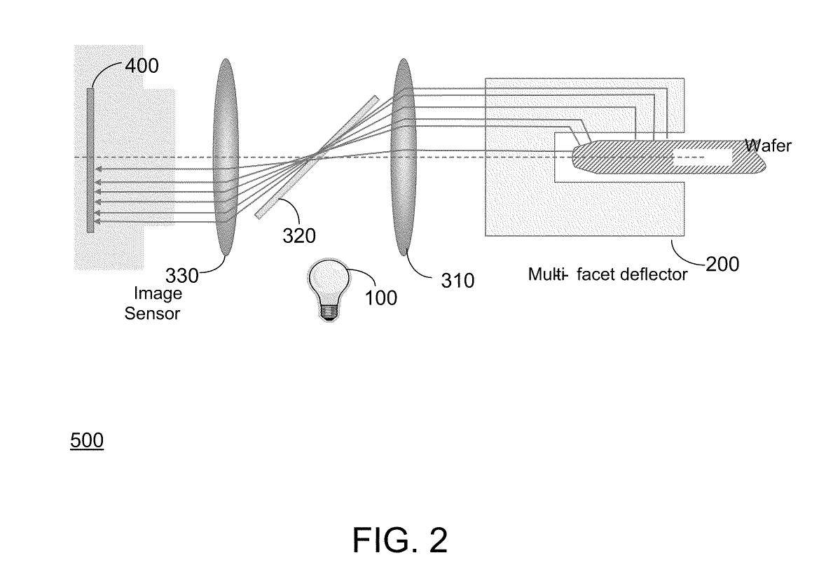

FIG. 2 illustrates system 500 and wafer 100 according to an embodiment of the invention.

System 500 includes image sensor 400, light source 340, beam splitter 320, a pair of lenses 310 and 330 and a single optical element such as multi facet deflector 200 that at least partially surrounds edge 160 of wafer 100.

System 500 can include one or more lenses, apertures, glare stops, optical length equalizers and alike.

It is noted that refractors can be used in addition to or instead of deflectors.

System 500 transfers images of different facets of edge 160 and projects it onto image sensor 400.

System 500 illustrates an on axis illumination path that includes light source 340 and beam splitter 320. It can, additionally or alternatively, include other types of illumination paths such as tilted illumination. The light from an illumination path may be shone directly onto the object, or can pass through fiber optics or lenses. Light sources of system 500 can include incandescent lamps, LEDs, arc lamps, flash tubes, laser, and the like. A light source of system 500 can be continuous or intermittent, or any combination thereof. System 500 can also include at least one of the following components: image processor, stage, and the like. If, for example the inspected object is circular the stage can rotate the object about a central axis.

Multi facet deflector 200 concurrently collects light reflected or scattered from multiple facets of wafer 100 and directs the collected light towards (even via additional optics such as lenses 310 and 330) image sensor 400. Multi facet deflector 200 converts the set of images acquired from the various facets into a planar image.

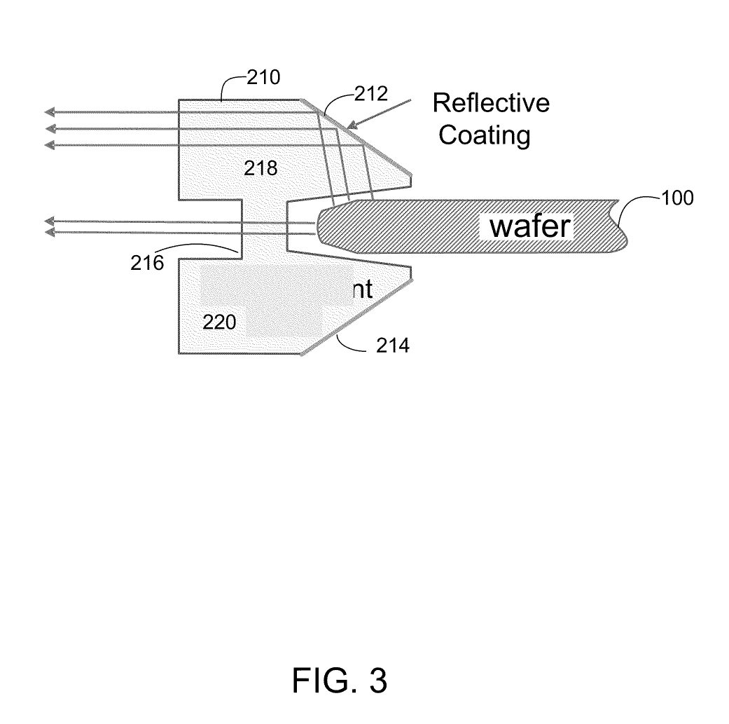

In the example of FIG. 3 multi facet deflector 210 includes three portions—upper portion 218 that collects light from top facet 110 and top bevel facet 120 of edge 160, middle portion 216 that collects light from apex 130 and lower portion 220 that collects light from bottom facet 150 and bottom bevel facet 140 of edge 160.

Multi facet deflector 210 is followed by path length adjustment optics (not shown) that reduces the differences between the optical paths of light that passes through middle portion 216 and light that passes through upper portion 218 and lower portion 220. The difference in reduction can amount in equalizing the length of the different optical paths.

Path length adjustment optics is illustrated in PCT patent application serial number WO07129322A2 titled “SYSTEM AND METHOD FOR IMAGING OBJECTS” which is incorporated herein by reference.

Path length adjustment optics can pass light through retarding lenses or other optical components that have higher refractive index than gas.

For example, it can include retarding lens between upper and lower portions 218 and 220 and image sensor 400 that will virtually shorten the optical length of optical paths associated with these portions.

The path length adjustment optics can include path folding mirrors. The first folding mirror is positioned and angled with respect to the object's apex as to reflect an image of the apex to second folding mirror. The second mirror, in turn, is positioned and angled so as to reflect an image of the apex from first mirror to imaging sensor 400. Changing the distance between the first and second folding mirrors can determine the lengthening of the optical path of the top collection path.

Additionally or alternatively, multi facet deflector 210 can reduce the difference as upper portion 218 and lower portion 218 and much wider (along an imaginary horizontal axis) than middle portion 216.

Multi facet deflector 210 is made of optical grade, transparent material that is shaped such that light rays entering from facets 110, 120, 130, 140 and 150 are reflected toward image sensor 110, parallel to an imaginary optical axis that extends towards the image sensor. It is noted that although FIG. 3 illustrates a horizontal line this is not necessarily so. (It is noted that the entire system may be oriented in any direction, as long as the relative positions of the inspected object and described system are maintained).

In this embodiment this reflection is achieved by forming facet “a” 212 of upper portion 218 at an appropriate angle and coating it with reflective material or attaching a mirror to it. A similar embodiment can use internal reflection at facets “a” utilizing a prism principle. Facet “b” of lower and upper portions 218 and 220 can be undercut or drilled through to equalize the optical path lengths of the various light beams.

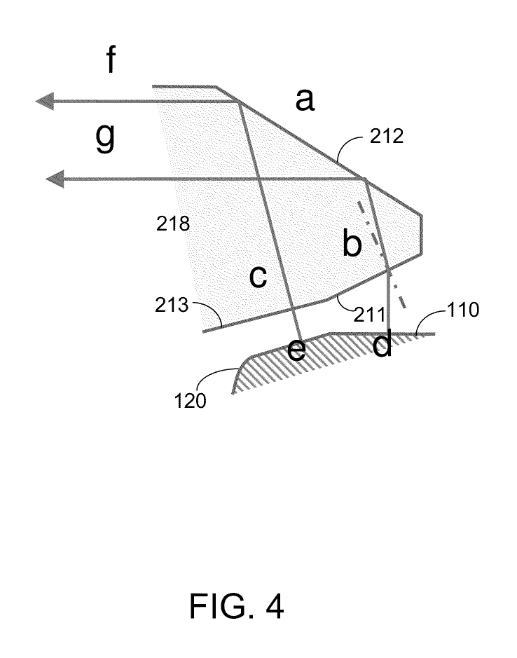

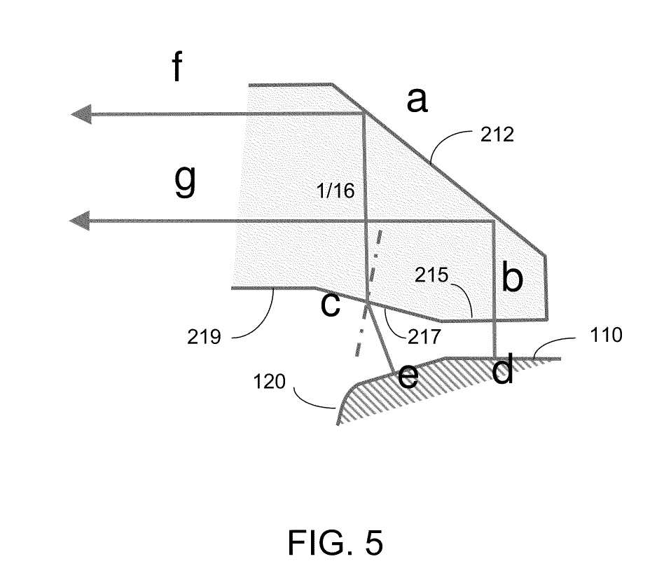

FIGS. 4 and 5 illustrate cross sections of portions of multi facet deflector according to various embodiments of the invention.

FIG. 4 illustrates facet “a” 212 that is formed at an angle smaller than 45° to the principle axis, such that a light beam “f” coming at a normal angle to top bevel facet (“e”) of the object passes un refracted through deflector facet “c” 213, hits the reflecting deflector facet “a” 212 and is reflected towards image sensor 400 in a parallel path to the principle axis. Deflector facet “b” 211 is angled such that a light beam “g” coming at a normal angle to top facet (“d”) of the inspected object refracts as it crosses deflector facet “b” 211 and proceeds parallel to beam “f”.

FIG. 5 illustrates a deflector facet “a” 212 that forms a 45° angle with the principle axis such that it reflects light beams at a straight angle. Light beam “f” refracts in crossing deflector facet “c” 217, while beam “g” emitted from top facet “d” 110 passes straight through deflector facet “b” 215 and proceeds parallel to beam “f”.

Similar geometries can be applied to other shapes of inspected objects.

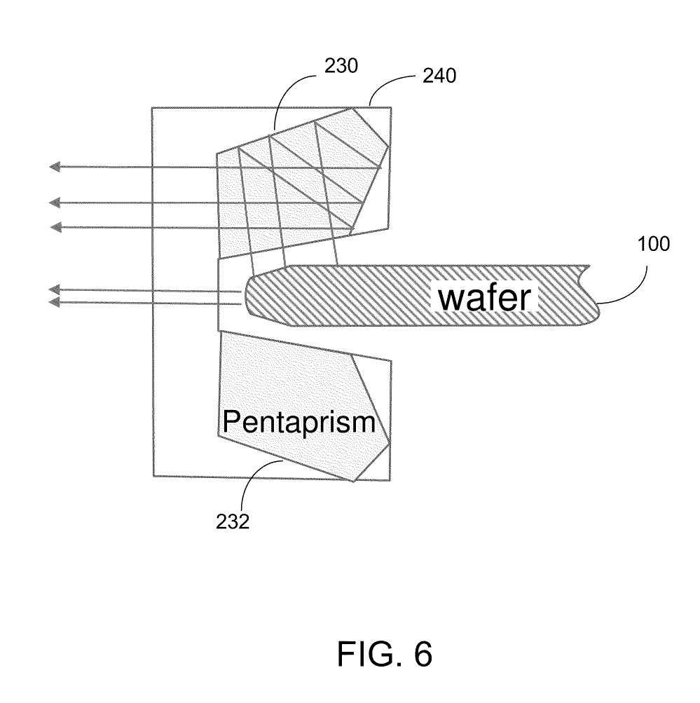

In the example of FIG. 6 an optical element includes a pair of multi faceted prism such as a penta-prism. These are also referred to as a top optical element and a bottom optical element.

One penta-prism is located above the inspected object while the second penta-prism is located below the inspected object. Each penta-prism transfers an erect image and can better equalize optical path lengths of light that is reflected at different angles and/or from different locations of the objects. These penta-prisms can either be installed in a holding frame, or formed by machining a block made of transparent material. As illustrated in FIG. 5, the facets facing the inspected object can be further shaped to refract light beams at normal angles to the object's facets.

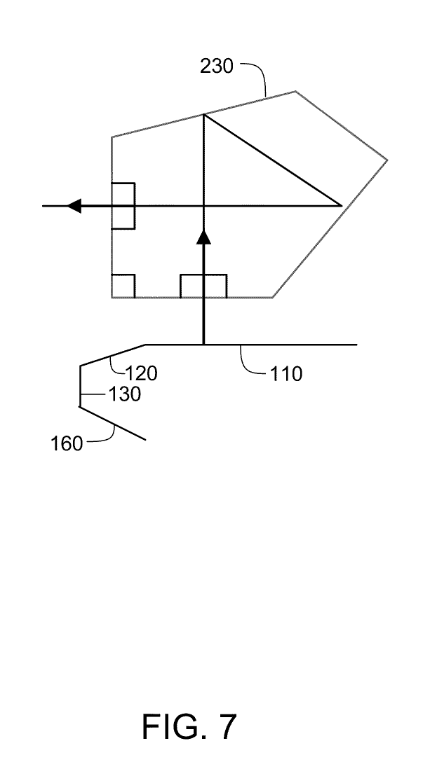

FIG. 7 illustrates multiple light rays that pass through the upper (top) penta-prism 230.

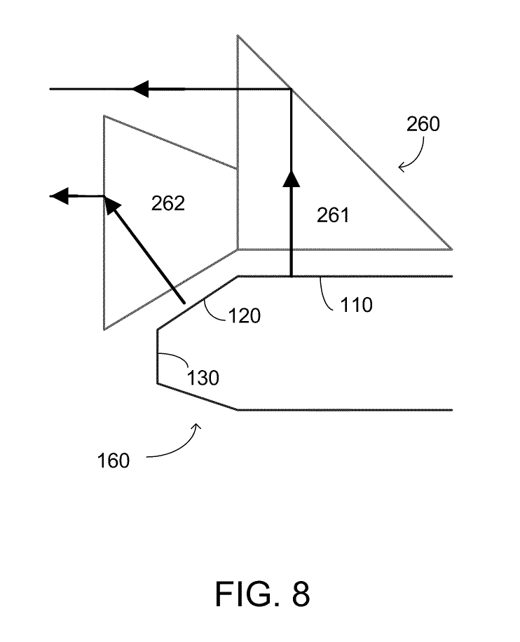

FIG. 8 illustrates edge 160 (and some of its facets—110, 120 and 130) as well as a upper portion of a multi facet deflector 260 that has multiple portions that differ from each other by their shape so that one portion 261 reflects light from top facet 110 towards an image sensor while the second portion 262 is shaped to reflect light from top bevel facet 120.

A deflecting facet of first portion 261 is oriented in an angle of 45° in relation to the horizon and deflects a vertical light from top facet 110 towards the horizon (towards image sensor).

A lower facet of second portion 262 is parallel to top bevel facet 120 while another facet is vertical. Light that is reflected at 90° from top bevel facet 120 is deflected by the vertical facet of second portion 262 by 135° and exits second portion 262 at a horizontal direction.

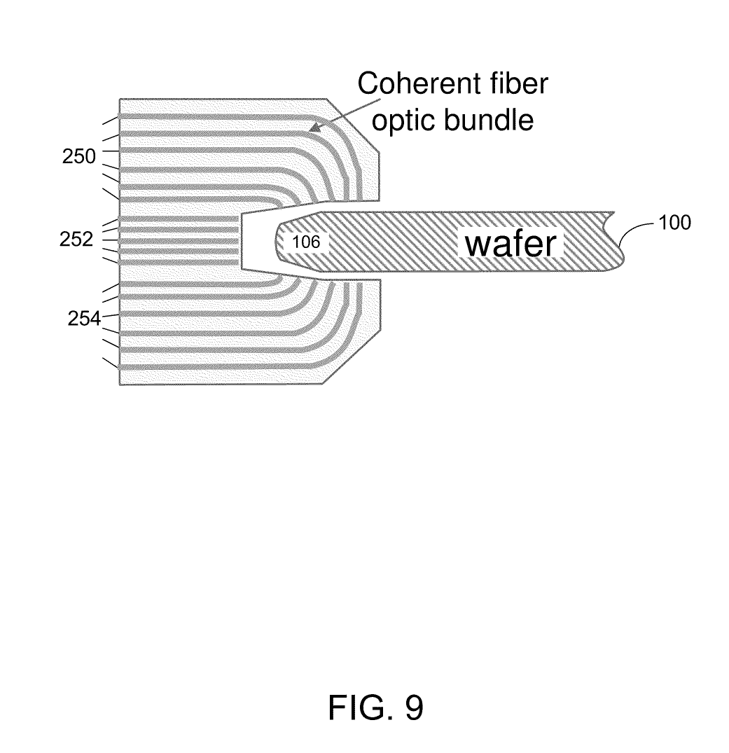

FIG. 9 illustrates multiple fibers 250, 252 and 254 that are arranged such as to at least partially surrounds edge 106.

A first group of fibers 250 collects light from top facet 110 and from top bevel facet 120. A second group of fibers 252 collects light from apex 130. A third group of fibers 254 collects light from bottom facet 150 and from bottom bevel facet 140.

These fibers can be held by (integrated within) a multi facet deflector but this is not necessarily so. The diameter and density of the fibers should match the required optical resolution.

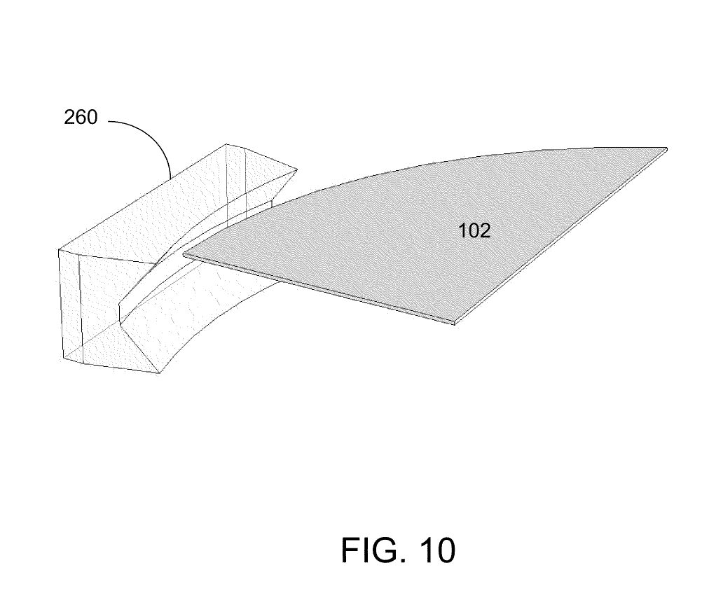

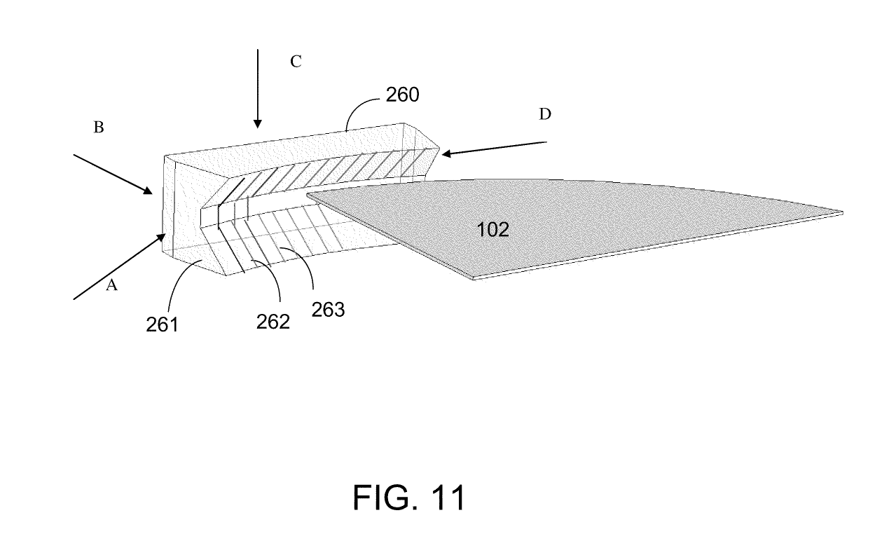

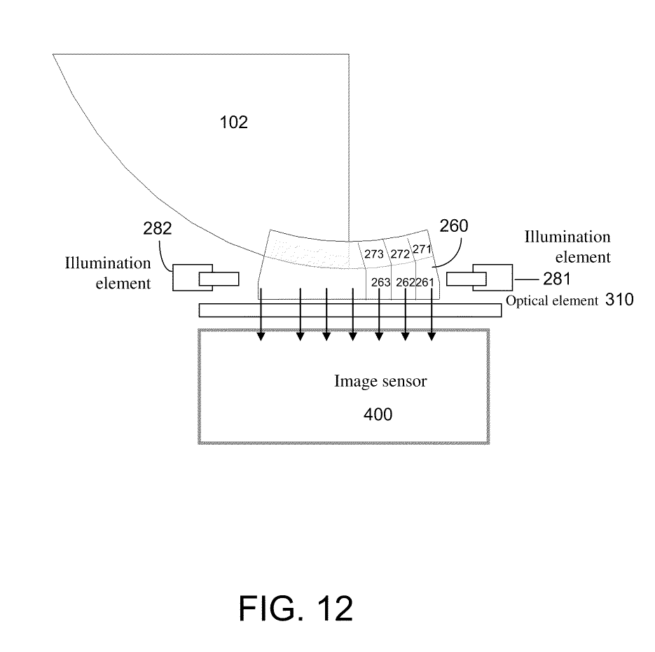

FIGS. 10 and 11 illustrate portion 102 of wafer (that rotates about its center) and optical element 260 according to an embodiment of the invention. Wafer 102 rotates about its center, as illustrated by the dashed curved arrow. FIG. 12 also illustrates illumination elements 281 and 282, optics elements 310 and image sensor 400.

Optical element 260 includes multiple sub elements (such as sub elements 261, 262 and 263) that differ from each other by at least one optical characteristic.

The difference can be introduced by a difference of at least one of the following characteristics of the sub element and especially of a surface of the each sub element: quality of surface, coating of surface, optical characteristic of a surface, geometrical shape of surface, material of surface, treatment of material of surface, optical characteristics of material, polarizing effect, depolarizing effect, and the like.

The above mentioned difference can introduce a difference in an illumination or light collection from each sub element of the wafer that is either illuminated by the sub element and, additionally or alternatively, from which light is collected by that sub element.

For example, when the edge of the wafer is illuminated from at least one of possible directions A, B, C and D the illumination or collection introduced by each sub element can differ by its angular coverage, magnification, polarization, intensity, color filter, spectral range, and the like.

During inspection wafer 102 is rotated around it center and explores it edge to each sub element out of 261, 262 and 263.

Image sensor 400 will grab images of wafer edge 160 through each of sub elements 261, 262 and 263 and can process each of the optically acquired information in various manners.

Accordingly, system 500 acquires, per each region of the wafer edge the system will acquire several images—according to the number of sub elements of optical element 260.

Sub regions 261, 262 and 263 collect light from regions 271, 272 and 273 of wafer 100. Each region can include a combination of at least two areas out of a top area, a top bevel area, an apex area, a bottom bevel area and a bottom area.

System 600 can process image information associated with each different sub element (261, 262 and 263) individually according to the pre-defined set of operators and rules and/or in any combination with data acquired from neighbor area of wafer edge according to the same or other pre-defined set of operators and rules.

System 600 can combine the results of the process and analysis of a set of several images representing appropriated area on wafer edge and will decide about flaws found and classify it according to the pre-defined set of operators and rules.

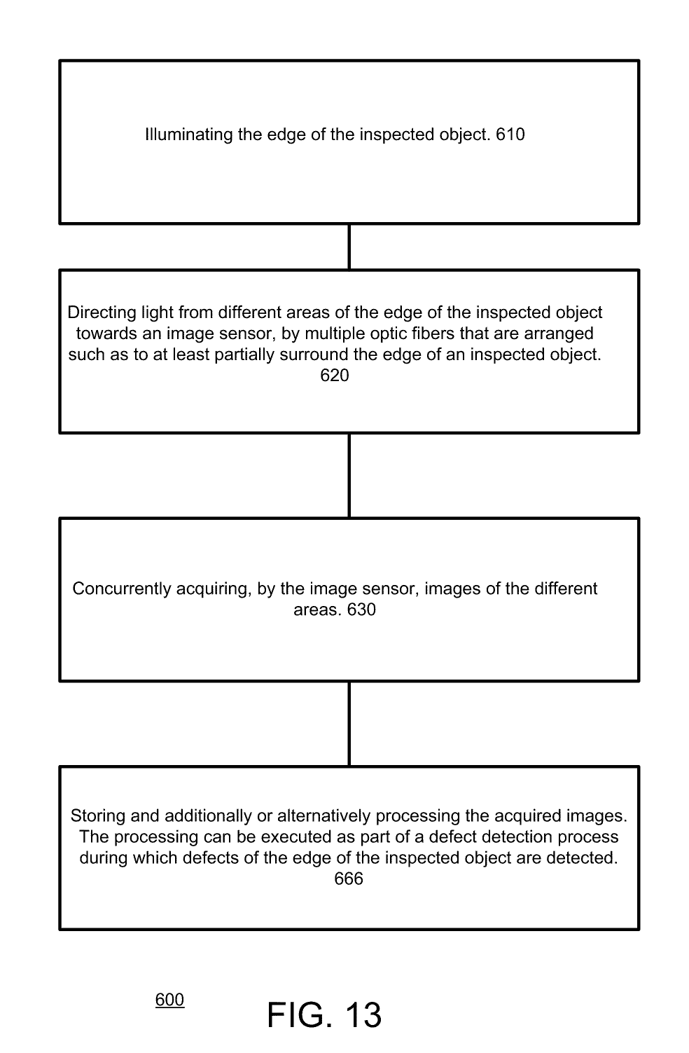

FIG. 13 illustrates method 600 for inspecting an edge of an inspected object, according to an embodiment of the invention.

Method 600 starts by stage 610 of illuminating the edge of the inspected object. The illumination can include on-axis illumination, off-axis illumination, pulsed illumination, continuous illumination, and the like.

Stage 610 is followed by stage 620 of directing light from different areas of the edge of the inspected object towards an image sensor, by multiple optic fibers that are arranged such as to at least partially surround the edge of an inspected object.

Each area can be a facet or a portion of a facet. A single facet can include multiple areas out of the different areas.

Stage 620 is followed by stage 630 of concurrently acquiring, by the image sensor, images of the different areas. Conveniently, these images do not overlap.

Stage 630 can be followed by stage 666 of storing and additionally or alternatively processing the acquired images. The processing can be executed as part of a defect detection process during which defects of the edge of the inspected object are detected. Thus stage 666 can include well known defect processing methods such as comparing to a reference, comparing one portion of the edge to another, comparing to expected results, and the like.

Method 600 can be executed by utilizing various systems and optical components, including but not limited to systems and optics illustrated in FIGS. 2, 3, 4, 5, 6, 7, 8, 10, 11 and 12.

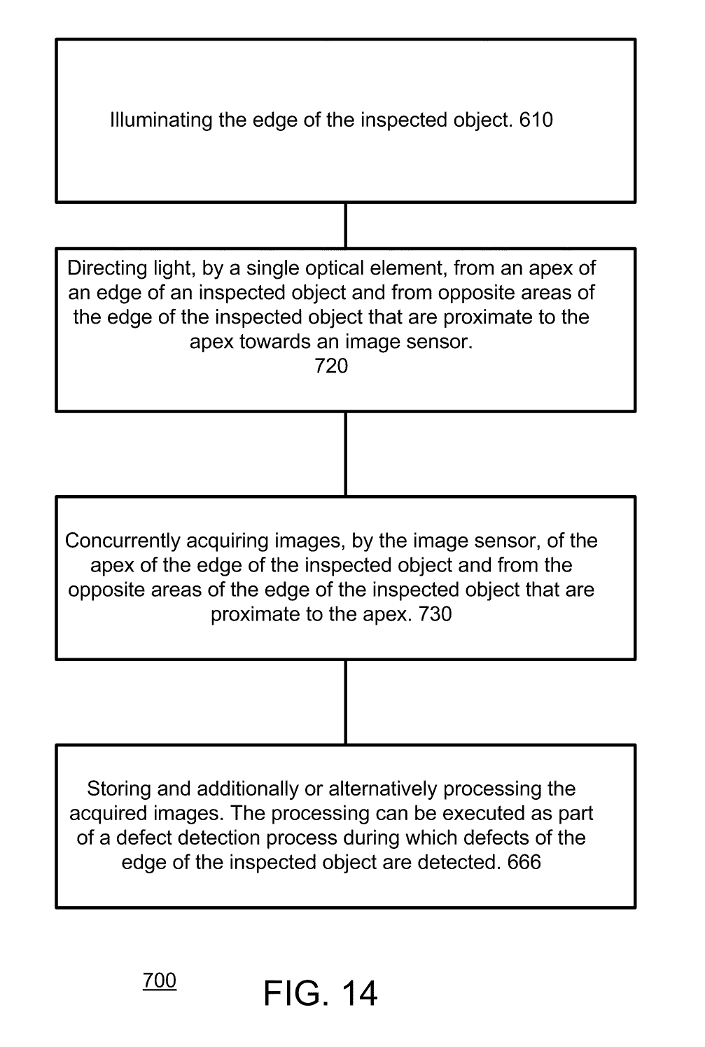

FIG. 14 illustrates method 700 for inspecting an edge of an inspected object, according to an embodiment of the invention.

Method 700 starts by stage 610 of illuminating the edge of the inspected object.

Stage 610 is followed by stage 720 of directing light, by a single optical element, from an apex of an edge of an inspected object and from opposite areas of the edge of the inspected object that are proximate to the apex towards an image sensor.

Stage 720 is followed by stage 730 of concurrently acquiring images, by the image sensor, of the apex of the edge of the inspected object and from the opposite areas of the edge of the inspected object that are proximate to the apex.

Stage 730 can be followed by stage 666 of storing and additionally or alternatively processing the acquired images. The processing can be executed as part of a defect detection process during which defects of the edge of the inspected object are detected. Thus stage 666 can include well known defect processing methods such as comparing to a reference, comparing one portion of the edge to another, comparing to expected results, and the like.

Method 700 can be executed by utilizing various systems and optical components, including but not limited to systems and optics illustrated in FIGS. 2, 3, 4, 5, 8, 10, 11 and 12.

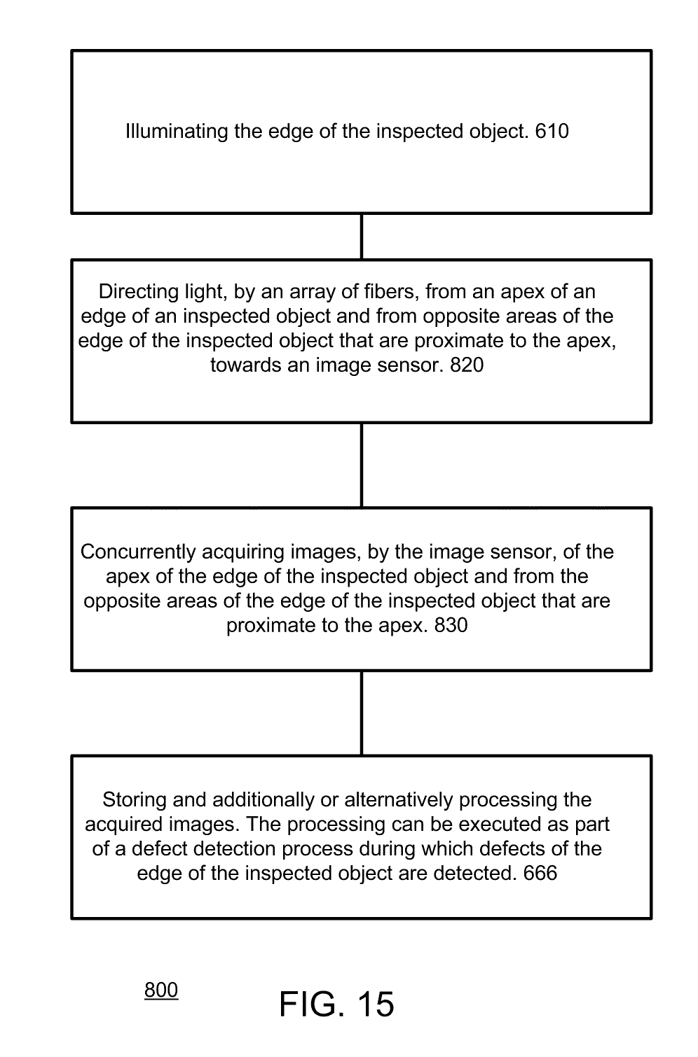

FIG. 15 illustrates method 800 for inspecting an edge of an inspected object, according to an embodiment of the invention.

Method 800 starts by stage 610 of illuminating the edge of the inspected object.

Stage 610 is followed by stage 820 of directing light, by an array of fibers, from an apex of an edge of an inspected object and from opposite areas of the edge of the inspected object that are proximate to the apex, towards an image sensor.

Stage 820 is followed by stage 830 of concurrently acquiring images, by the image sensor, of the apex of the edge of the inspected object and from the opposite areas of the edge of the inspected object that are proximate to the apex.

Stage 830 can be followed by stage 666 of storing and additionally or alternatively processing the acquired images. The processing can be executed as part of a defect detection process during which defects of the edge of the inspected object are detected. Thus stage 666 can include well known defect processing methods such as comparing to a reference, comparing one portion of the edge to another, comparing to expected results, and the like.

Method 600 can be executed by utilizing various systems and optical components, including but not limited to systems and optics illustrated in FIG. 9.

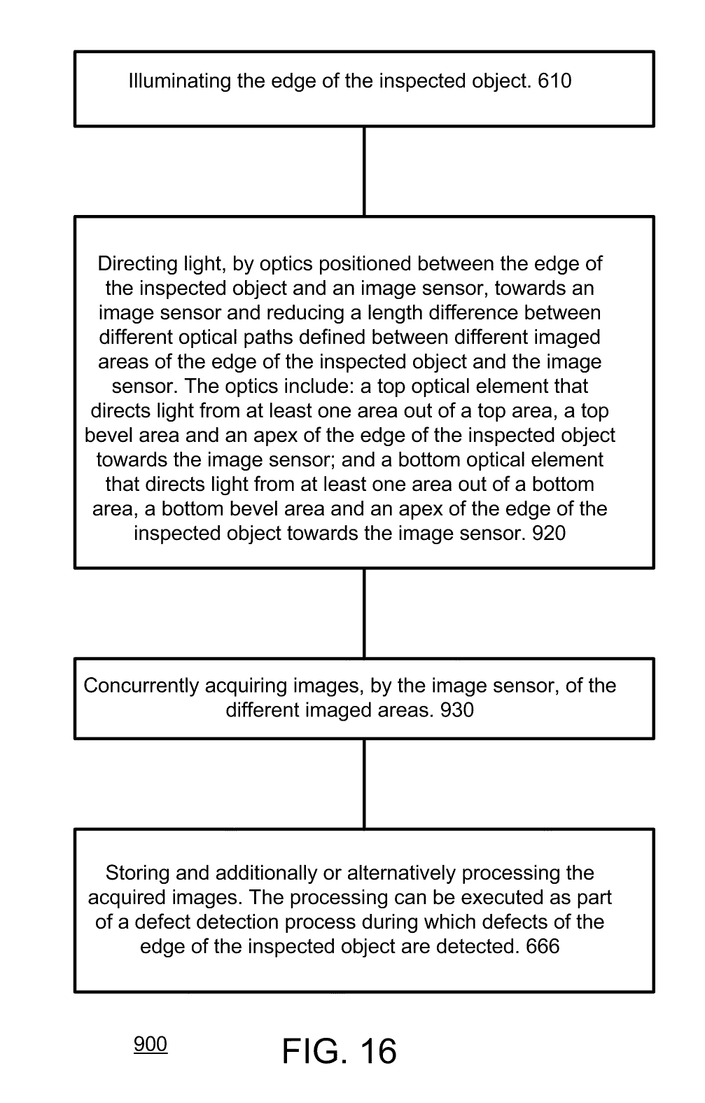

FIG. 16 illustrates method 900 for inspecting an edge of an inspected object, according to an embodiment of the invention.

Method 900 starts by stage 610 of illuminating the edge of the inspected object.

Stage 610 is followed by stage 920 of directing light, by optics positioned between the edge of the inspected object and an image sensor, towards an image sensor and reducing a length difference between different optical paths defined between different imaged areas of the edge of the inspected object and the image sensor. The optics include: a top optical element that directs light from at least one area out of a top area, a top bevel area and an apex of the edge of the inspected object towards the image sensor; and a bottom optical element that directs light from at least one area out of a bottom area, a bottom bevel area and an apex of the edge of the inspected object towards the image sensor.

Stage 920 is followed by stage 930 of concurrently acquiring images, by the image sensor, of the different imaged areas.

Stage 930 can be followed by stage 666 of storing and additionally or alternatively processing the acquired images. The processing can be executed as part of a defect detection process during which defects of the edge of the inspected object are detected. Thus stage 666 can include well known defect processing methods such as comparing to a reference, comparing one portion of the edge to another, comparing to expected results, and the like.

Method 900 can be executed by utilizing various systems and optical components, including but not limited to systems and optics illustrated in FIGS. 2, 3, 4, 5, 6, 7, 8, 10, 11 and 12.

It is noted that any combination of stages of any method out of methods 600, 700, 800 and 900 can be provided, as long as the combination does not include stages that contradict each other.

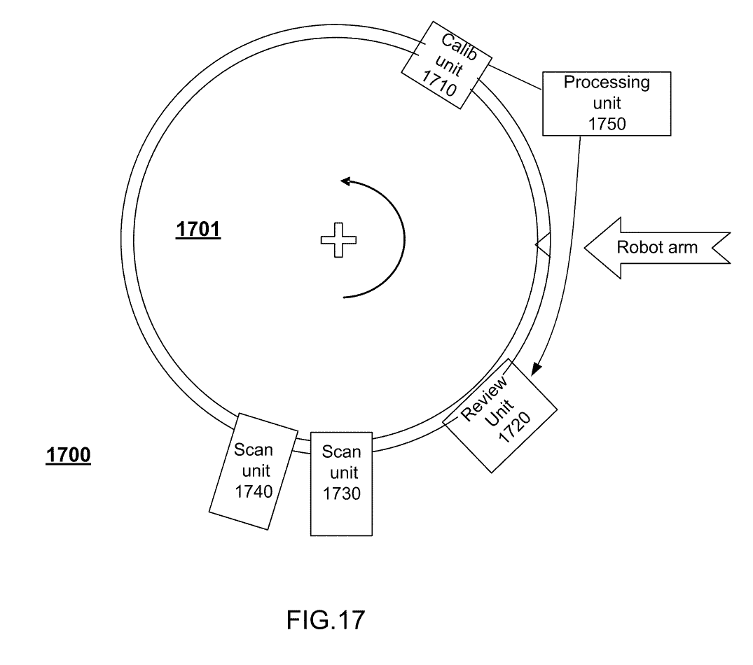

FIG. 17 illustrates a system 1700 and an inspected object 1701 according to an embodiment of the invention.

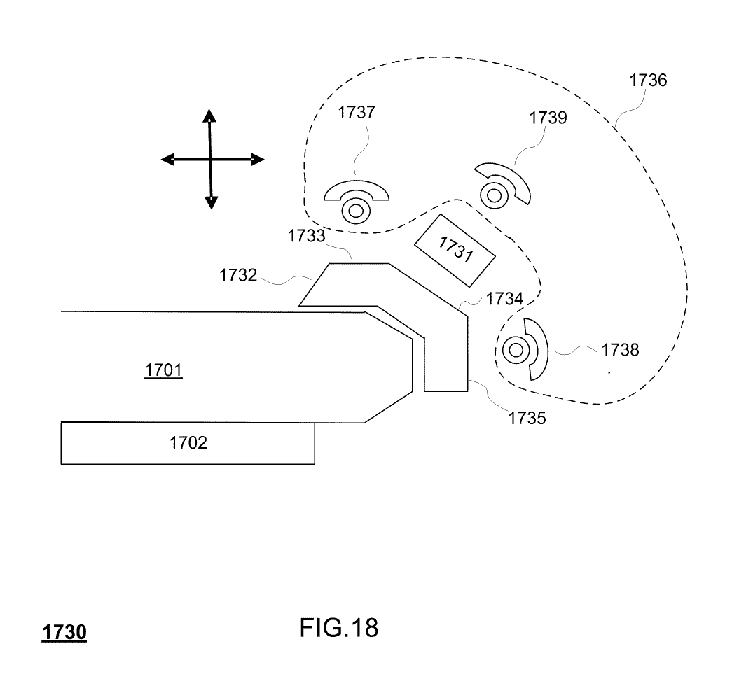

System 1700 includes calibration unit 1710, review unit 1720, first scan unit 1730 and second scan unit 1740. System 1700 also includes a supporting module (denoted 1702 in FIGS. 18, 19, 20, 21, and 22) that supports and rotates inspected object 1701.

Inspected object 1701 is circular and is rotated about its axis by the supporting module. Calibration unit 1710, review unit 1720, first scan unit 1730 and second scan unit 1740 are positioned near the edge of inspected object 1701 once the inspected object 1701 is placed on the supporting module.

The inspected object 1701 can be rotated in a clockwise manner, and additionally or alternatively, in a counterclockwise manner.

A defect detection sequence can include at least one of the following: (i) rotating the inspected object 1701 once and detecting suspected defects by one or more scanning units, (ii) rotating the inspected object 1701 multiple times while maintaining the illumination conditions and/or collection condition the same during the multiple rotations, (iii) rotating the inspected object 1701 multiple times while changing one or more illumination conditions and/or one or more collection condition during these multiple rotations, (iv) valuating or reviewing the suspected defects by the review unit 1720.

An illumination condition can include type of illumination (bright field, dark field), polarization of illumination, numerical aperture of illumination, color of illuminating light, magnification, intensity of illumination, angle of incidence, and the like.

A collection condition can include sensitivity of sensor, polarization, angle of collection, numerical aperture of collection, a filtering parameter, magnification, and the like.

The images that are collected during one or more rotations of inspected object 1701 can be analyzed for suspected defects. Images of the same region of the edge area can be correlated or otherwise processed in order to increase the reliability of the defect detection process or in order to facilitate a detection of detects of more types. An analysis rule can declare a suspected defect only if it appears in multiple images of the same region, under different illumination and/or collection conditions.

Calibration unit 1710, review unit 1720, first scan unit 1730 and second scan unit 1740 are spaced apart from each other. They can be arranged in other arrangements that illustrated in FIG. 17. For example—the review unit 1720 can be positioned between the first and second scan units 1730 and 1740.

Calibration unit 1710 can determine a position of the edge of the inspected object 1701. It can measure the thickness of the inspected object 1701 and various deviations from estimated location during the scan and/or review process. Calibration unit 1710 sends location signals to either one of the first scan unit 1730, second scan unit 1740 and review unit 1720 that in turn can move their image sensors or optics in order to maintain a desired distance between them and the edge of the inspected object.

The determination of the position of the edge of the inspected object, the generation of location signals and especially the introduction of movement between the edge of the inspected object and the optics or image sensors require an adjustment period.

According to an embodiment of the invention the rotational speed of the inspected object and the distance between the calibration unit 1710 are set to allow a completion of these stage before the segment of the edge of the inspected object that arrived to the calibration unit 1710 arrives to either one of the first scan unit 1730, the second scan unit 1740 and the review unit 1720.

First scan unit 1730 includes a first image sensor and a first optical element, for directing light from the top area, from the top bevel area and from the apex area towards the first image sensor.

Second scan unit 1740 includes a second image sensor; and a second optical element, for directing light from the bottom area, from the bottom bevel area and from the apex area towards the second image sensor.

FIG. 18 illustrates first scan unit 1730 according to an embodiment of the invention.

First scan unit 1730 includes first image sensor 1731 and a first optical element 1732, for directing light from the top area, from the top bevel area and from the apex area towards the first image sensor 1731.

The first optical element 1732 includes a first segment 1733 that faces the top area, a second segment 1734 that faces the top bevel area and a third segment 1735 that faces the apex area.

Each of the first, second and third segments 1733, 1734 and 1735 has an inner facet that is parallel to an outer facet of that segment.

The second segment 1734 and the first image sensor 1731 are substantially parallel to the top bevel area.

FIG. 18 also illustrates an illumination module 1736 for directing light through the first optical element and towards the top area, the top bevel area and the apex area.

Illumination module 1736 includes two dark-field illumination units 1737 and 1738 and a bright field illumination unit 1739.

The first dark field illumination unit 1737 directs light through the first segment 1733 of the first optical element 1732 and towards the top area and top bevel area.

The second dark-field illumination unit 1738 directs light through the third portion 1735 and towards the apex area.

The bright field illumination unit 1739 directs light through the second portion 1734 and towards the top bevel area. It is noted that although FIG. 18 illustrates first image sensor 1731 as being positioned between the top bevel area and the bright field illumination unit 1739 it should be noted that in practice bright field illumination unit 1739 can be located at a different position and direct light towards a beam splitter (not shown) that is positioned between the first image sensor 1731 and the second portion 1734.

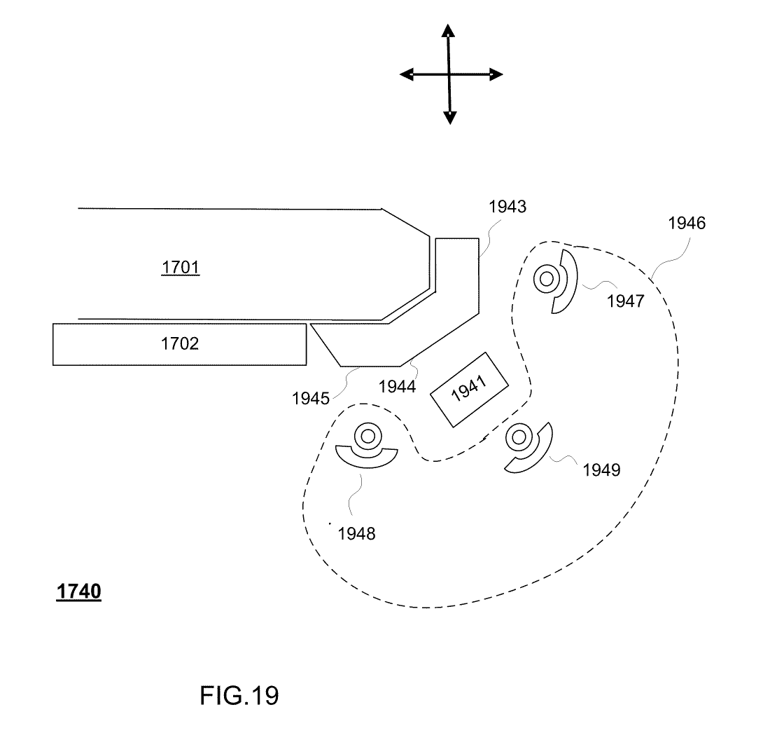

FIG. 19 illustrates second scan unit 1740 according to an embodiment of the invention.

Second scan unit 1740 includes second image sensor 1941 and a second optical element 1942, for directing light from the bottom area, from the bottom bevel area and from the apex area towards the second image sensor 1941.

The second optical element 1942 includes a first segment 1943 that faces the apex area, a second segment 1944 that faces the bottom bevel area and a third segment 1945 that faces the bottom area.

The second segment 1944 and the second image sensor 1941 are substantially parallel to the bottom bevel area.

Each of the first, second and third segments 1943, 1944 and 1945 has an inner facet that is parallel to an outer facet of that segment.

FIG. 19 also illustrates an illumination module 1946 for directing light through the second optical element and towards the bottom area, the bottom bevel area and the apex area.

Illumination module 1946 includes two dark-field illumination units 1947 and 1948 and a bright field illumination unit 1949.

The first dark field illumination unit 1947 directs light through the first segment 1943 of the first optical element 1942 and towards the apex.

The second dark-field illumination unit 1948 directs light through the third portion 1945 and towards the bottom area and the bottom bevel area.

The bright field illumination unit 1949 directs light through the second portion 1944 and towards the bottom bevel area. It is noted that although FIG. 19 illustrates second image sensor 1941 as being positioned between the top bevel area and the bright field illumination unit 1949 it should be noted that in practice bright field illumination unit 1949 can be located at a different position and direct light towards a beam splitter (not shown) that is positioned between the second image sensor 1941 and the second portion 1944.

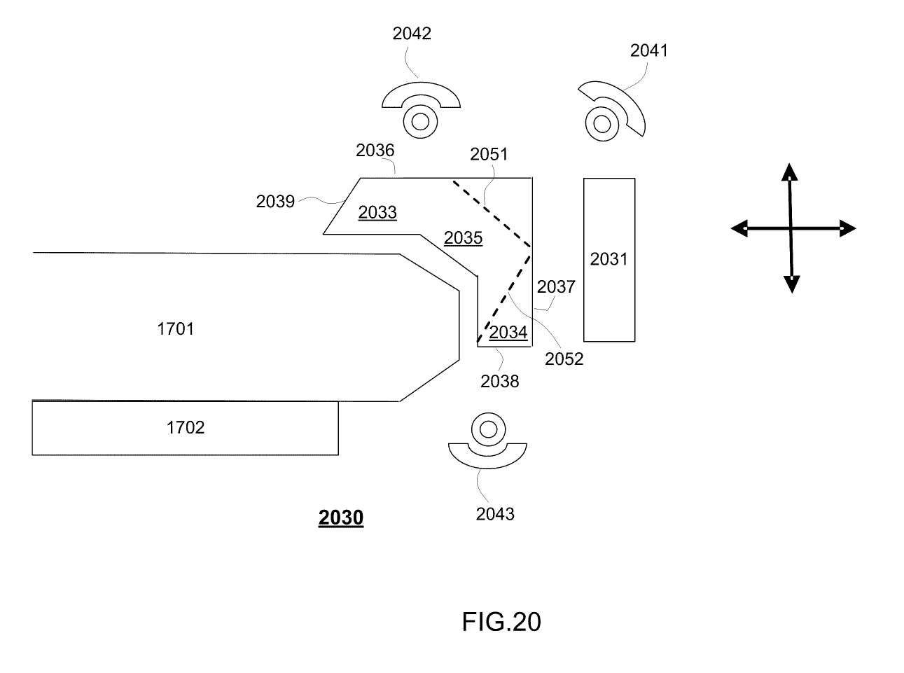

FIG. 20 illustrates first scan unit 2030 according to another embodiment of the invention.

First scan unit 2030 includes first image sensor 2031 and a first optical element 2032, for directing light from the top area, from the top bevel area and from the apex area towards the first image sensor 2031.

The first image sensor 2031 is vertical and is parallel to the apex area and to an outer surface 2037 of the first optical element 2032.

The first optical element 2032 includes a first segment 2033 that faces the top area, a second segment 2034 that faces the top bevel area and a third segment 2035 that faces the apex area.

Each of the first, second and third segments 2033, 2034 and 2035 has an inner facet that is parallel to an outer facet of that segment. The first optical element 2032 also includes two outer facets 2036 and 2037 that are oriented in relation to the inner facets. FIG. 20 illustrates first outer facet 2036 as being parallel to top area and second outer facet 2037 as being parallel to the apex area.

First optical element 2032 also includes two additional outer facets 2038 and 2039. Third outer facet 2038 is parallel to the top facet and it faces dark-field illumination unit 2041.

In addition, first optical element 2032 also includes a first beam splitter 2051 and a second beam splitter 2052. The first beam splitter 2051 is located at the top right area of first optical element 2032.

The second beam splitter 2052 is located at the bottom right area of first optical element 2032.

FIG. 20 also illustrates an illumination module 2040 for directing light through the first optical element and towards the top area, the top bevel area and the apex area.

Illumination module 2040 includes bright field illumination unit 2041 and two dark field illumination units 2042 and 2043.

Bright field illumination unit 2041 directs light through first beam splitter 2051 to upper bevel area. Light from the upper bevel area is directed by the first beam splitter 2051 towards first image sensor 2031.

The first dark field illumination unit 2043 directs light through the second beam splitter 2052 towards the apex are. The first dark field illumination unit 2043 is positioned below the first optical element 2032 and directs its light through a vertical path to second outer facet 2038 of first optical element 2032.

The second dark field illumination unit 2142 is positioned above the second optical element 2132 and directs its light through first segment 2133 and to the bottom area.

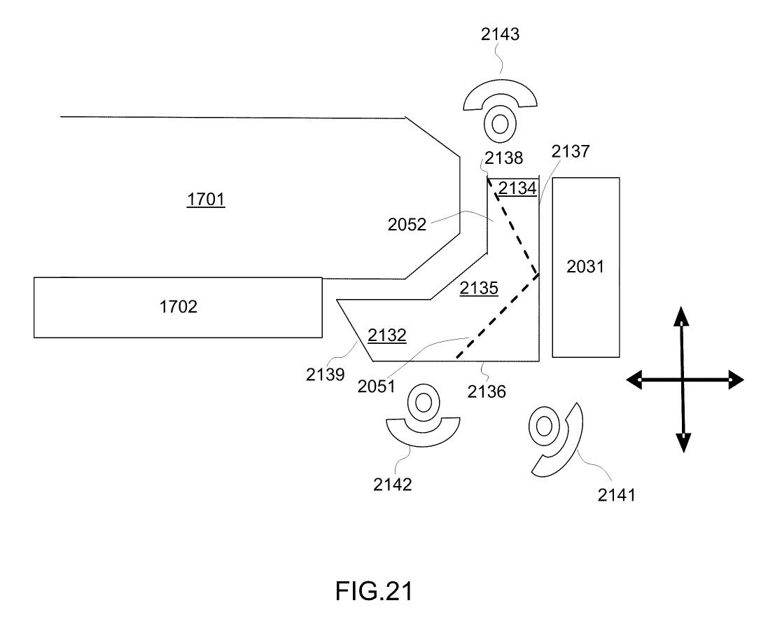

FIG. 21 illustrates second scan unit 2130 according to another embodiment of the invention.

Second scan unit 2130 includes second image sensor 2131 and a second optical element 2132, for directing light from the bottom area, from the bottom bevel area and from the apex area towards the second image sensor 2131.

The second image sensor 2131 is vertical and is parallel to the apex area and to an outer surface 2137 of the second optical element 2132.

The second optical element 2132 includes a first segment 2133 that faces the bottom area, a second segment 2134 that faces the bottom bevel area and a third segment 2135 that faces the apex area.

Each of the first, second and third segments 2133, 2134 and 2135 has an inner facet that is parallel to an outer facet of that segment.

The second optical element 2132 also includes two outer facets 2136 and 2137 that are oriented in relation to the inner facets.

FIG. 21 illustrates first outer facet 2137 as being parallel to the apex and second outer facet 2136 as being parallel to the bottom bevel area.

Second optical element 2132 also includes two additional outer facets 2138 and 2139. Third outer facet 2138 is parallel to the bottom facet and it faces dark-field illumination unit 2143.

In addition, second optical element 2132 also includes a first beam splitter 2151 and a second beam splitter 2152. The first beam splitter 2151 is located at the bottom right area of second optical element 2132. The second beam splitter 2152 is located at the top right area of second optical element 2132.

FIG. 21 also illustrates an illumination module 2140 for directing light through the second optical element and towards the bottom area, the bottom bevel area and the apex area.

Illumination module 2140 includes bright field illumination unit 2141 and two dark field illumination units 2142 and 2143.

Bright field illumination unit 2141 directs light through first beam splitter 2151 to bottom bevel area. Light from the bottom bevel area is directed by the first beam splitter 2151 towards second image sensor 2131.

The first dark field illumination unit 2143 directs light through the second beam splitter 2152 towards the apex area. The first dark field illumination unit 2143 is positioned above the second optical element 2132 and directs its light through a vertical path to second outer facet 2138 of second optical element 2132.

The second dark field illumination unit 2142 is positioned below the second optical element 2132 and directs its light through first segment 2133 and to the bottom area.

In the above description (associated with FIGS. 17-21) the illumination units were described as illuminating one or more area of the edge. It is noted that each illumination unit can also illuminate an additional one or more areas. For example—light from bright field illumination unit 1739 of FIG. 18 can illuminate a portion of the apex area and/or a portion of the top area. The same applied to the collection of light.

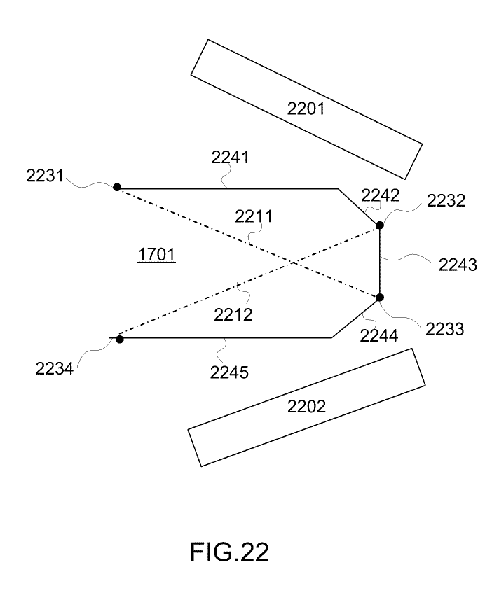

FIG. 22 illustrates an edge of an inspected object 1701 and two image sensors 2201 and 2202 according to an embodiment of the invention.

First image sensor 2201 can belong to first scan unit 1730 while the second image sensor 2202 can belong to second scan unit 1740.

For clarity of description various components were omitted fro FIG. 22. These components may include optical elements, illumination units and the like.

First image sensor 2201 is parallel to a first imaginary axis 2211 that stretches between a bottom point 2233 of apex area 2243 and between a top area point 2231 located at the top area 2241. The angle between the top area 2241 and the first imaginary axis 2211 is smaller than the angle between the top bevel area 2242 and the top area 2245. In other words—the first imaginary axis 2211 is less inclined than the top bevel area 2242.

Second image sensor 2202 is parallel to a second imaginary axis 2212 that stretches between an upper point 2232 of apex area 2243 and between a bottom area point 2234 located at the bottom area 2245. The angle between the bottom area 2245 and the second imaginary axis 2212 is smaller than the angle between the bottom bevel area 2244 and the bottom area 2245. In other words—the second imaginary axis 2212 is less inclined than the bottom bevel area 2242.

This arrangement allows the first and second image sensors 2201 and 2202 to obtain light from multiple areas simultaneously even without optical elements such as the first and second optical elements of previous figures.

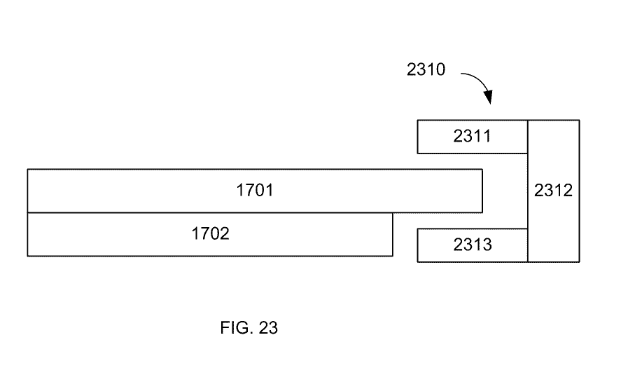

FIG. 23 illustrates calibration unit 2310 according to an embodiment of the invention.

Calibration unit 2310 includes three distance sensors 2311, 2312 and 2313, each may sense the distance and/or orientation of an area of the edge of inspected object 2301. Upper distance sensor 2311 senses a distance to the top area. Intermediate distance sensor 2312 senses a distance to the apex area. Bottom distance sensor 2313 senses a distance to the bottom area.

It is noted that each of these sensors can measure the distance or orientation (or both distance and orientation) of one or more areas of the edge of the inspected object 1701.

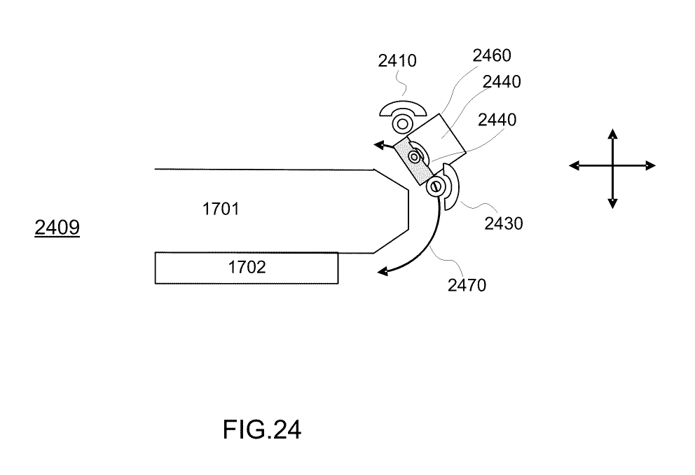

FIG. 24 illustrates a review unit 2400 according to an embodiment of the invention.

Review unit 2400 is coupled to processing unit 2460. Processing unit 2460 receives images from either one of image sensors of the first and second scan units (illustrated in either one of FIGS. 17-23) and is configured to analyze images obtained by at least one of the first and second image sensor for suspected wafer defects. One processing unit 2460 locates suspected units it sends review unit 2400 information relating to these suspected defects (such as location) and review unit 240 acquires images of these suspected defects.

Review unit 2400 includes review camera 2401 for obtaining images of the suspected defects, bright field illumination unit 2440, dark field illumination units 2420 and 2410 and optics 2430 for directing light towards the edge of the inspected object 1701 and from the edge of the inspected object.

The optical element can be a first optical element such as the optical element illustrated in FIG. 18 or 20.

Conveniently, the review unit 2400 includes a rotating module 2470 that rotates the review camera 2401, and additionally or alternatively the optics 2430 about an axis such as to change an angle between the review camera 2401 and the edge of the inspected object 1701.

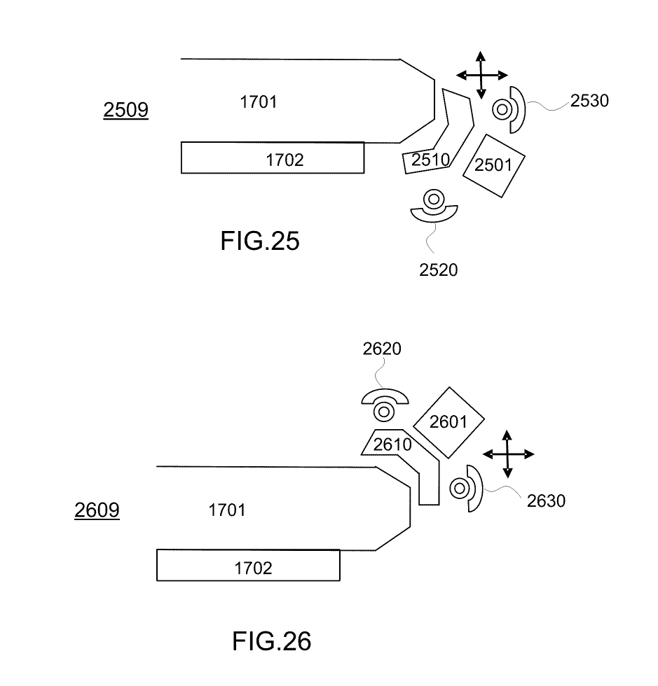

FIG. 25 illustrates second review unit 2500 according to an embodiment of the invention.

Second review unit 2500 includes second review camera 2501 and a second optical element 2510, for directing light from the top area, from the top bevel area and from the apex area towards the second review camera 2501.

The second optical element 2510 includes a first segment that faces the top area, a second segment that faces the top bevel area and a third segment that faces the apex area. Each of the first, second and third segments has an inner facet that is parallel to an outer facet of that segment.

The second segment and the second review camera 2501 are substantially parallel to the top bevel area.

FIG. 25 also illustrates two dark-field illumination units 2520 and 2530.

The first dark field illumination unit 2520 directs light through the first segment of the first optical element 2510 and towards the top area and top bevel area.

The second dark-field illumination unit 2530 directs light through the third portion and towards the apex area.

FIG. 26 illustrates first review unit 2600 according to an embodiment of the invention.

First review unit 2600 includes first review camera 2601 and a first optical element 2610, for directing light from the top area, from the top bevel area and from the apex area towards the first review camera 2601.

The first optical element 2610 includes a first segment that faces the top area, a second segment that faces the top bevel area and a third segment that faces the apex area. Each of the first, second and third segments has an inner facet that is parallel to an outer facet of that segment.

The second segment and the first review camera 2601 are substantially parallel to the bottom bevel area.

FIG. 26 also illustrates two dark-field illumination units 2620 and 2630.

The first dark field illumination unit 2620 directs light through the first segment of the first optical element 2610 and towards the bottom area and the bottom bevel area.

The second dark-field illumination unit 2630 directs light through the third portion and towards the apex area.

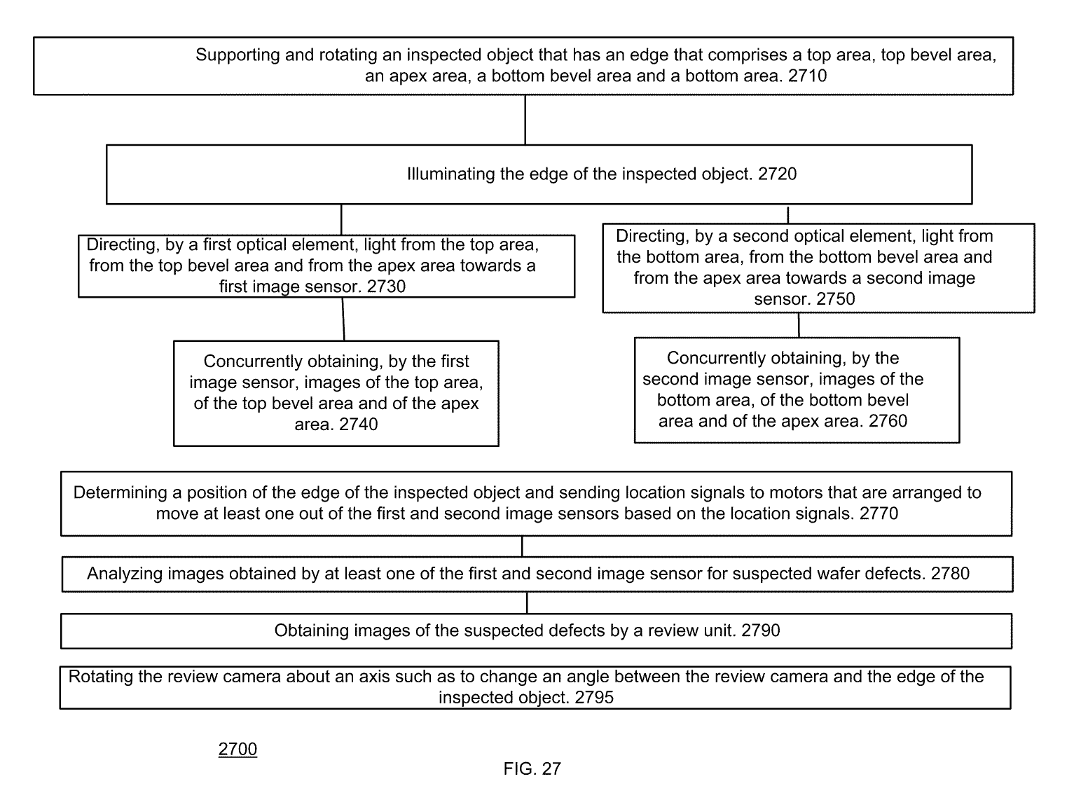

FIG. 27 illustrates an inspection method 2700 according to an embodiment of the invention.

Method 2700 starts by stage 2710 of supporting and rotating an inspected object that has an edge that comprises a top area, top bevel area, an apex area, a bottom bevel area and a bottom area.

Stage 2710 is followed by stages 2720, 2730 and 2750.

Stage 2720 includes illuminating the edge of the inspected object.

Stage 2730 includes directing, by a first optical element, light from the top area, from the top bevel area and from the apex area towards a first image sensor.

Stage 2730 is followed by stage 2740 of concurrently obtaining, by the first image sensor, images of the top area, of the top bevel area and of the apex area.

Stage 2750 includes directing, by a second optical element, light from the bottom area, from the bottom bevel area and from the apex area towards a second image sensor.

Stage 2750 is followed by stage 2760 of concurrently obtaining, by the second image sensor, images of the bottom area, of the bottom bevel area and of the apex area.

Stage 2730 can include at least one of the following or a combination thereof: (i) directing light by the first optical element that includes a first segment that faces the top area, a second segment that faces the top bevel area and a third segment that faces the apex area, (ii) directing light by a first optical element that includes a second segment, wherein the second segment and the first image sensor are substantially parallel to the top bevel area; (iii) directing light through the first optical element and towards the top area, the top bevel area and the apex area; (iv) directing light through the first segment of the first optical element towards the top area and top bevel area, (v) directing light by a first optical element that a first, second and third segments, wherein each of the first, second and third segments has an inner facet that is parallel to an outer facet of the segment; (vi) directing light by the first optical element that comprises a first inner facet that faces the top area, a second inner fact that faces the top bevel area, a third inner facet that faces the apex area, a first outer facet and a second outer facet, wherein the first and second outer facets are oriented in relation to the first, second and third inner facets; (vii) directing light by a first optical element that has a first and second outer facets, wherein the first image sensor faces an outer facet out of the first and second outer facets of the first optical element; (viii) directing light by a first optical element that includes at least one beam splitter; (ix) directing light towards the first beam splitter and to the top bevel area; wherein the first beam splitter is arranged to direct light from the top bevel area to the first light sensor.

Method 2700 can also include stage 2770 of determining a position of the edge of the inspected object and sending location signals to motors that are arranged to move at least one out of the first and second image sensors based on the location signals.

Method 2700 can also include stage 2780 of analyzing images obtained by at least one of the first and second image sensor for suspected wafer defects, and stage 2790 of obtaining images of the suspected defects by a review unit.

Stage 2790 can be preceded or followed by stage 2795 of rotating the review camera about an axis such as to change an angle between the review camera and the edge of the inspected object.

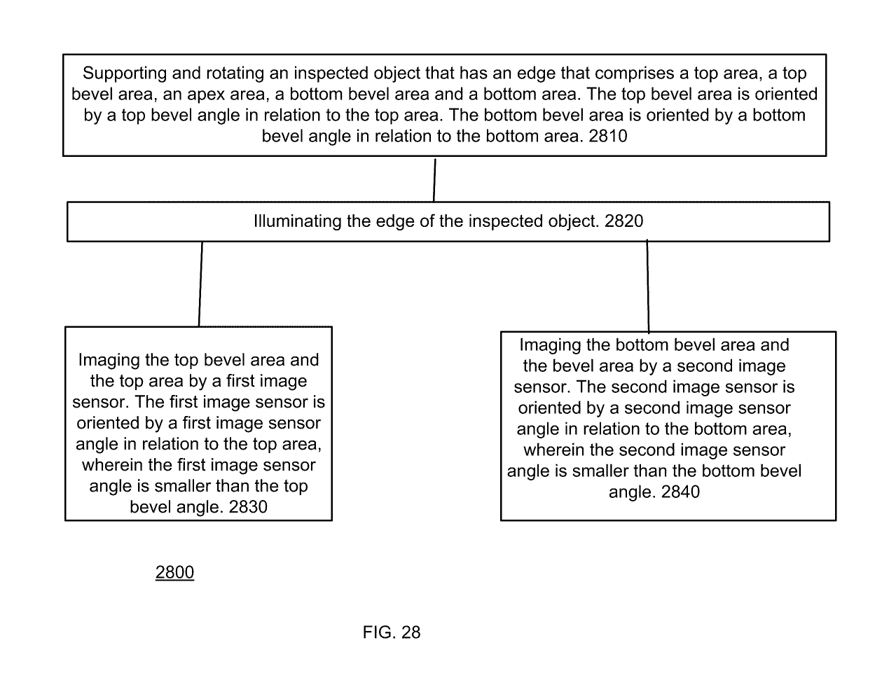

FIG. 28 illustrates an inspection method 2800 according to an embodiment of the invention.

Method 2800 starts by stage 2810 of supporting and rotating an inspected object that has an edge that comprises a top area, a top bevel area, an apex area, a bottom bevel area and a bottom area. The top bevel area is oriented by a top bevel angle in relation to the top area. The bottom bevel area is oriented by a bottom bevel angle in relation to the bottom area.

Stage 2810 is followed by stages 2820, 2830 and 2840.

Stage 2820 includes illuminating the edge of the inspected object.

Stage 2830 includes imaging the top bevel area and the top area by a first image sensor. The first image sensor is oriented by a first image sensor angle in relation to the top area, wherein the first image sensor angle is smaller than the top bevel angle.

Stage 2840 includes imaging the bottom bevel area and the bevel area by a second image sensor. The second image sensor is oriented by a second image sensor angle in relation to the bottom area, wherein the second image sensor angle is smaller than the bottom bevel angle.

The second image sensor angle can equal a half of the bottom bevel angle.

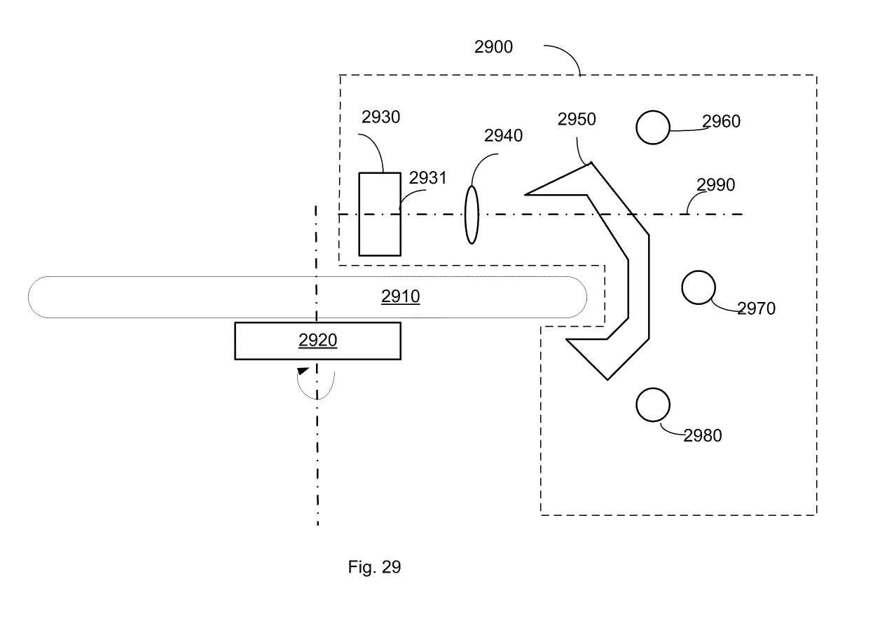

FIG. 29 illustrates an inspection system 2900 and a inspected object 2910 according to an embodiment of the invention.

The inspected object 2910 is supported by a stage 2920 that rotates the inspected object 2910 about a center of the inspected object 2910.

The system 2900 includes a camera 2930 that is positioned above the inspected object 2910 and has a sensing surface 2931 that faces an upper portion of a multi-facet reflector 2950 that directs toward the sensing surface 2931 light from various facets of the edge of the inspected object 2910. An objective lens 2940 is positioned between the camera 2930 and the multi-facet reflector 2950.

Different facets of the multi-facet reflector 2950 face different areas of the edge of the inspected object 2910. FIG. 29 illustrates the multi-facet reflector 2950 as partially surrounding the edge of the inspected object 2910.

FIG. 29 illustrates the camera 2930 as having an optical axis 2990 that is parallel to the inspected object 2910 (to the upper surface to the inspected object 2910) but this is not necessarily so and the optical axis 2910 can be oriented in relation to an upper surface of the inspected object.

The system 2900 can maintain still while the inspected object 2910 is rotated about its center. It is noted that the system 2900 or either one of its components (camera 2930, objective lens 2940, multi-facet reflector 2950) can slightly move (for example, along a x-axis), for example, for focusing purposes—to compensate for differences in the location of the edge of the inspected object.

FIG. 29 illustrates system as including two diffusive illumination light sources 2960 and 2980 and one reflective illumination light source 2970 but fewer, additional or other light sources can be used. FIG. 29 illustrates light source 2960 as facing a top bevel area of the edge of the inspected object 2910, light source 2980 as facing a bottom bevel area of the edge of the inspected object 2910 and light source 2970 as facing the apex area of the edge of the inspected object 2910. It is noted that either one of these light sources may be positioned in a different position.

It is noted that the multi-facet reflector 2950 can be replaced by a single optical element that can direct light from at least one of the top bevel area, the apex area or the top area. The single optical element can be a prism, a mirror, a reflector, a deflector and the like.

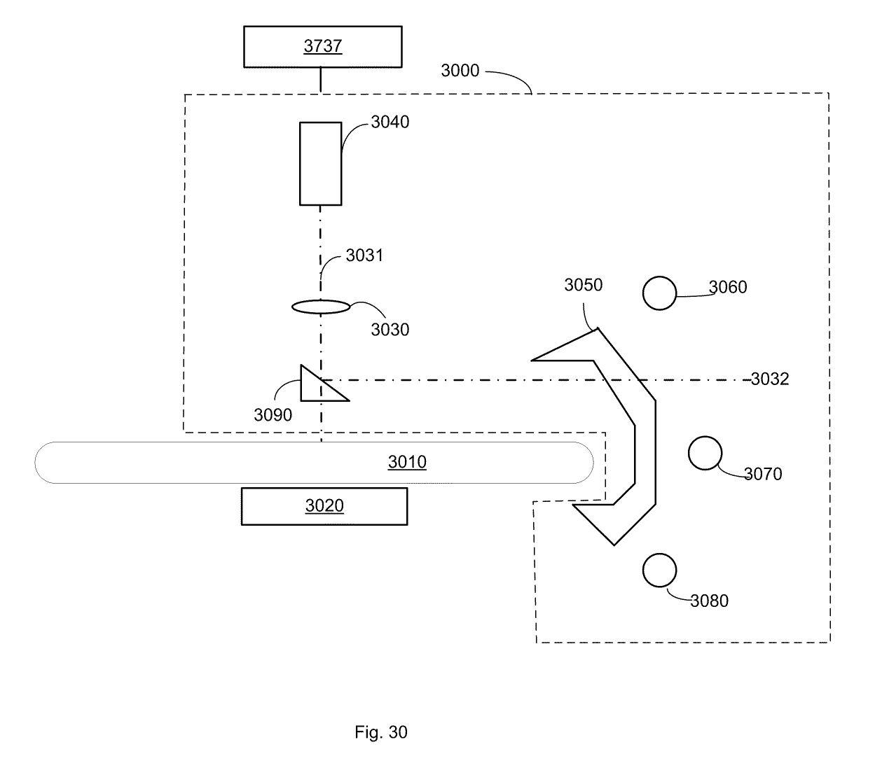

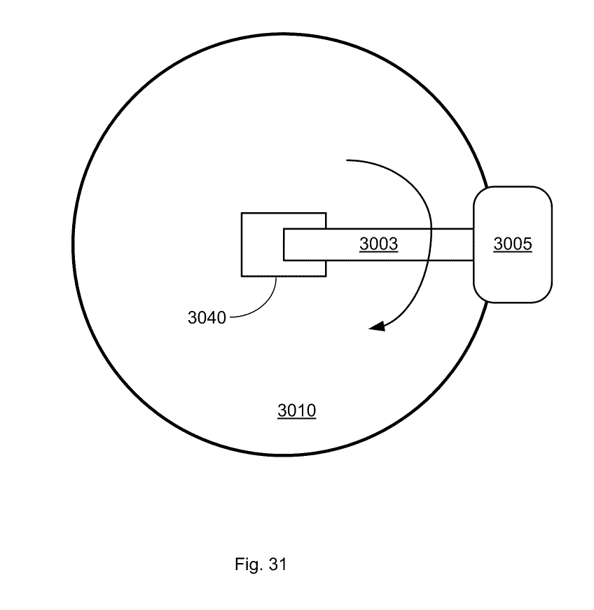

FIGS. 30 and 31 are a side view and a top view of a system 3000 and an inspected object 3010 according to an embodiment of the invention.

FIG. 30 illustrates various optical components (3030, 3040, 3050, 3060, 3070, 3080 and 3090) of system 3000 while FIG. 31 illustrates a mechanical element 3003 and an optical head 3005. The optical head 3005 is connected to mechanical element 3003. Both (3003 and 3005) are rotated (by a rotating element that is not shown in FIGS. 30 and 31) about an axis (3031) while the inspected object 3010 is maintained still. The optical head 3005 can also be slightly moved for auto-focus purposes—especially for compensating for deviations of the location of the edge of the inspected object 3010.

The optical components includes a camera 3040 that is positioned above the center of the inspected object 3010 (although it may be positioned elsewhere) and is illustrated as having an optical axis 3031 that is normal to the upper surface of the inspected object 3010. The camera 3040 receives light through an objective lens 3030 from a 90 degrees mirror 3090 that converts horizontally propagating light (that propagates along optical axis 3032) to vertically propagating light. It is noted that the mirror 3090 can reflect light at an angle that differs from 90 degrees and that the optical axes 3032 and 3031 can deviate from those illustrated in FIG. 30.

The mirror 3090 receives the light from a multi-facet reflector 3050 that directs toward the mirror 3090 from various facets of the edge of the inspected object 3010. Different facets of the multi-facet reflector 3050 face different areas of the edge of the inspected object 3010. FIG. 30 illustrates the multi-facet reflector 3050 as partially surrounding the edge of the inspected object 3010.

FIG. 30 illustrates system as including two diffusive illumination light sources 3060 and 3080 and one reflective illumination light source 3070 but fewer, additional or other light sources can be used. FIG. 30 illustrates light source 3060 as facing a top bevel area of the edge of the inspected object 3010, light source 3080 as facing a bottom bevel area of the edge of the inspected object 3010 and light source 3070 as facing the apex area of the edge of the inspected object 3010. It is noted that either one of these light sources may be positioned in a different position.

It is noted that the multi-facet reflector 3050 can be replaced by a single optical element that can direct light from at least one of the top bevel area, the apex area or the top area. The single optical element can be a prism, a mirror, a reflector, a deflector and the like.

It is noted that the mirror 3090 and the multi-facet reflector 3050 may be rotated while the camera 3040 and objective lens 3030 remain still.

FIG. 30 illustrates a rotator 3737 that is connected to system 3000 to illustrate that one or more components of system 3000 can be rotated. The rotator 3737 can be connected to the various optical components by mechanical elements (not shown) that are known in the art.

It is noted that the illumination light sources (such as illumination light sources 3060, 3070 and 3080) can be replaced by illumination elements that are positioned above the mirror 3090 and direct light towards the mirror 3090, whereas the mirror 3090 directs the light towards the multi-facet reflector 3050 and towards the edge of the inspected element. Such illumination light sources can have an optical axis that is the same as optical axis 3031, slightly deviates from the optical axis 3031 or even parallel to optical axis 3031. They can provide coaxial illumination without preventing the camera 3040 from imaging the edge of the inspected object. This can be achieved by using a beam splitter, using light fibers or other elements that may surround the camera and provide a ring of light or any other illumination such as bright field illumination.

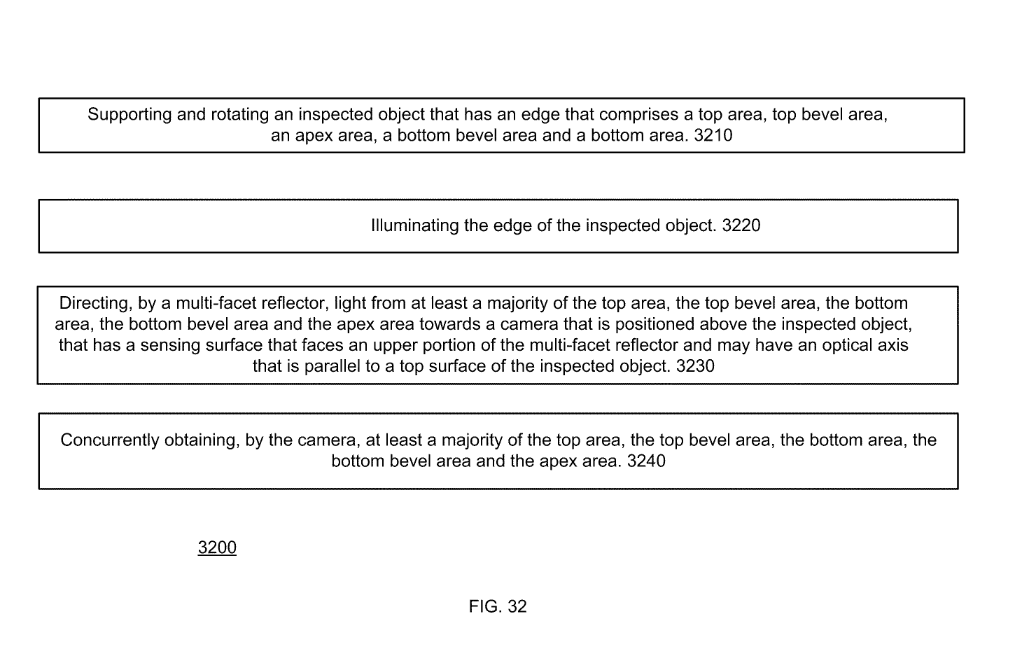

FIG. 32 illustrates an inspection method 3200 according to an embodiment of the invention.

Method 3200 starts by stage 3210 of supporting and rotating an inspected object that has an edge that includes a top area, top bevel area, an apex area, a bottom bevel area and a bottom area. The inspected object can be rotated about its center.

Stage 3210 is executed in parallel to stages 3220, 3230 and 3240.

Stage 3220 includes illuminating the edge of the inspected object.

Stage 3230 includes directing, by a multi-facet element, light from the top area, the top bevel area, the bottom area, the bottom bevel area and the apex area towards a camera that is located above the inspected object and may have an optical axis that is parallel to the upper surface of the inspected object. The camera has a sensing surface that faces the upper portion of the multi-facet element. Stage 3230 can include any stages include din stage 2730 of FIG. 27.

Stage 3240 includes concurrently obtaining, by the camera, images of the top area, the top bevel area, the bottom area, the bottom bevel area and the apex area.

Method 3200 can also include various stages that may be equivalent to: (i) stage 2770 of determining a position of the edge of the inspected object and sending location signals to motors that are arranged to move at least one out of the first and second image sensors based on the location signals; (ii) stage 2780 of analyzing images obtained by at least one of the first and second image sensor for suspected wafer defects, and (iii) stage 2790 of obtaining images of the suspected defects by a review unit.

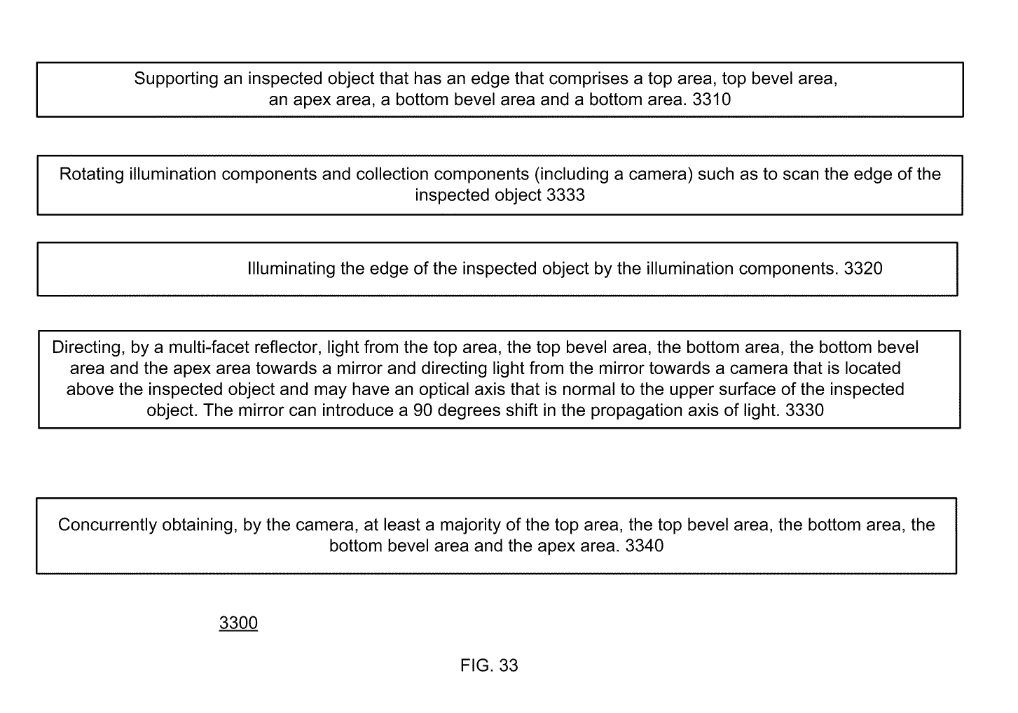

FIG. 33 illustrates an inspection method 3300 according to an embodiment of the invention.

Method 3300 starts by stages 3310 and 3333.

Stage 3310 includes supporting an inspected object that has an edge that includes a top area, top bevel area, an apex area, a bottom bevel area and a bottom area. The inspected object can be rotated about its center.

Stage 3333 includes rotating illumination components and collection components (including a camera) such as to scan the edge of the inspected object 3333.

Stages 3310 and 3333 may be is executed in parallel to stages 3320, 3330 and 3340.

Stage 3320 includes illuminating the edge of the inspected object.

Stage 3330 includes directing, by a multi-facet element, light from the top area, the top bevel area, the bottom area, the bottom bevel area and the apex area towards a mirror and directing light from the mirror towards a camera that is located above the inspected object and may have an optical axis that is normal to the upper surface of the inspected object. The mirror can introduce a 90 degrees shift in the propagation axis of light. Stage 3330 can include any stages included in stage 2730 of FIG. 27.

Stage 3340 includes concurrently obtaining, by the camera, images of the top area, the top bevel area, the bottom area, the bottom bevel area and the apex area.

Method 3300 can also include various stages that may be equivalent to: (i) stage 2770 of determining a position of the edge of the inspected object and sending location signals to motors that are arranged to move at least one out of the first and second image sensors based on the location signals; (ii) stage 2780 of analyzing images obtained by at least one of the first and second image sensor for suspected wafer defects, and (iii) stage 2790 of obtaining images of the suspected defects by a review unit.

It is noted that any of the mentioned above multi-facet reflectors can also allow light to propagate therethrough.

The present invention can be practiced by employing conventional tools, methodology, and components. Accordingly, the details of such tools, component, and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. An optical inspection system, comprising:
a first image sensor;
a second image sensor;
a support module for supporting and rotating an inspected object that has an edge that comprises a top area, top bevel area, an apex area, a bottom bevel area and a bottom area;
a first optical element, for directing light from the top area, from the top bevel area and from the apex area towards the first image sensor; and
a second optical element, for directing light from the bottom area, from the bottom bevel area and from the apex area towards the second image sensor.

2. The system according to claim 1, wherein the first optical element comprises a first segment that faces the top area, a second segment that faces the top bevel area and a third segment that faces the apex area.

3. The system according to claim 1, further comprising an illumination module for directing light through the first optical element and towards the top area, the top bevel area and the apex area.

4. The system according to claim 3, wherein the illumination module comprises a dark field illumination unit.

5. The system according to claim 1, comprising a bright field illumination unit.

6. The system according to claim 1, further comprising an calibration unit for determining a position of the edge of the inspected object and for sending location signals to motors that are arranged to move at least one out of the first and second image sensors based on the location signals.

7. The system according to claim 1, further comprising:
a processing unit for analyzing images obtained by at least one of the first and second image sensor for suspected wafer defects; and
a review unit that comprises a review camera for obtaining images of the suspected defects.

8. The system according to claim 7 wherein the review unit comprises a rotating module that rotates the review camera about an axis such as to change an angle between the review camera and the edge of the inspected object.

9. An inspection method, the method comprises: supporting and rotating an inspected object that has an edge that comprises a top area, top bevel area, an apex area, a bottom bevel area and a bottom area;
illuminating the edge of the inspected object;
concurrently obtaining, by the first image sensor, images of the top area, of the top bevel area and of the apex area; and
concurrently obtaining, by the second image sensor, images of the bottom area, of the bottom bevel area and of the apex area.

10. The method according to claim 9, comprising directing light by the first optical element that comprises a first segment that faces the top area, a second segment that faces the top bevel area and a third segment that faces the apex area.

11. The method according to claim 9, wherein the first optical element further comprises a second beam splitter.

12. The method according to claim 9, further comprising:
determining a position of the edge of the inspected object; and
sending location signals to motors that are arranged to move at least one out of the first and second image sensors based on the location signals.

13. The method according to claim 9, further comprising:
analyzing images obtained by at least one of the first and second image sensor for suspected wafer defects; and
obtaining images of the suspected defects by a review unit.

14. The method according to claim 9, comprising rotating the review camera about an axis such as to change an angle between the review camera and the edge of the inspected object.

15. An optical inspection system, comprising:
an image sensor; and
a single optical element, that at least partially surrounds an edge of an inspected object; wherein the optical element is adapted to direct light from different areas of the edge of the inspected object towards the image sensor so that the image sensor concurrently obtains images of the different areas;
wherein the image sensor is located above the inspected object and has an optical axis that is substantially parallel to an upper surface of the inspected object;
wherein the image sensor has a sensing surface that faces an upper portion of the single optical element; wherein the system further comprises a stage that rotates the inspected object about a center of the inspected object.

16. The system according to claim 15, wherein the single optical element is a multi-facet reflector.

17. The system according to claim 15, wherein the image sensor and a mirror are located above the inspected object; wherein the image sensor has a sensing surface that faces the mirror, wherein an upper portion of the single optical element faces the mirror; wherein system comprises a rotator for rotating at least the mirror and the single optical element in relation to the inspected object such as to scan the edge of the inspected object.

18. A method for inspecting an edge of an inspected object, the method comprises:
illuminating the edge of the inspected object; and
directing light from different areas of the edge of the inspected object towards an image sensor, by a single optical element, that at least partially surrounds an edge of an inspected object, towards the image sensor;
rotating at least the single optical element and a mirror that is located above the inspected object while concurrently obtaining images of the different areas by an image sensor that has a sensing surface that faces the mirror, wherein an upper portion of the multi-facet reflector faces the mirror.

19. THE method according to claim 18, comprising concurrently obtaining, by the image sensor, images of the different areas while rotating the inspected object about a center of the inspected object; wherein the image sensor is located above the inspected object and has an optical axis that is substantially parallel to an upper surface of the inspected object; wherein the image sensor has a sensing surface that faces an upper portion of the single optical element.
